(19) United States
(12) Patent Application Publication
(10) Pub. No.: US 2026/0355048 A1
(43) Pub. Date: Nov. 12, 2026

(54) MULTIPLE BLADDER THERAPEUTIC COMPRESSION APPARATUS, SYSTEM AND METHODS OF USE

(71) Applicant: Sun Scientific, Inc., Dobbs Ferry, NY (US)

(72) Inventors: Sundaram Ravikumar, Braircliff Manor, NY (US); Vikram Ravikumar, New York, NY (US); Guy Osborne, Trumbull, CT (US); Allan Alward, Shelton, CT (US)

(73) Assignee: Sun Scientific, Inc., Dobbs Ferry, NY (US)

(21) Appl. No.: 19/129,660

(22) PCT Filed: Nov. 15, 2023
(86) PCT No.: PCT/US2023/079854

§ 371 Date: May 13, 2025

Related U.S. Application Data
(63) Continuation-in-part of application No. 17/608,323, filed on Nov. 2, 2021.
(60) Provisional application No. 63/425,662, filed on Nov. 15, 2022.

(51) Int. Cl. A61H 9/00

(52) U.S. Cl. CPC A61H 9/0092; A61H 2201/0103; A61H 2201/1609; A61H 2201/1614; A61H 2201/1619; A61H 2201/1635; A61H 2201/164; A61H 2201/169; A61H 2201/5058; A61H 2205/04; A61H 2205/062; A61H 2205/065; A61H 2205/084; A61H 2205/106; A61H 2205/108

(57) ABSTRACT

An inventive therapeutic compression apparatus for a body limb including at least one wrap having at least two bladders configured to apply compression or pressure onto the limb as well as a universal inflation port for each bladder capable of connecting to both static and intermittent inflation means and includes a sealing means configured to include an open position and a closed position wherein the closed position maintains the at least one bladder in an inflated or deflated state and is in the open position when coupled to the inflation means so that the at least one bladder is the same inflation state as the inflation means. A method includes the steps of inflating and deflating each of the bladders to either the same or different pressure level and also capable of sequential inflation and deflation of each separate bladder.

### RELATED APPLICATIONS

The present application claims priority from PCT Application Number PCT/US2023/79854 filed Nov. 15, 2023 entitled “Multiple Bladder Therapeutic Compression Apparatus, System and Methods of Use” claiming priority from U.S. provisional application Ser. No. 63/425,662 filed on Nov. 15, 2022 and entitled “Multiple Bladder Therapeutic Compression apparatus, System and Methods of Use” and as a continuation-in-part from U.S. application Ser. No. 17/608,323 filed Nov. 2, 2021 and entitled “Therapeutic Compression System and Methods of Use” based on application Serial No. PCT/US2020/31227 filed May 2, 2020, based on application Ser. No. 62/842,165 filed May 2, 2019, the entire contents of which are hereby incorporated herein by reference for all purposes.

### BACKGROUND OF THE INVENTION

### Field of the Invention

The subject invention is directed generally to a system for applying compression to one or more limbs at the same time, and more particularly, to a system for applying compression to the leg and/or foot and/or thigh of an individual in conjunction with the treatment of conditions such as deep vein thrombosis (DVT), chronic venous insufficiency (CVI), lymphedema, and swelling. The system includes at least one inventive therapeutic compression apparatus, such as a wrap having more than one bladder and an inflation means for the bladders with the apparatus capable of applying compression to a limb such as the full leg, thigh, calf, knee, and/or foot of a patient, and a port connected to the inflation means wherein the bladders are inflated at the same time, with the same or different pressure levels, or sequentially.

### Background of the Related Art

Normally, a healthy muscle, for example, a healthy leg muscle squeezes the deep veins of the legs and feet to help move blood back to the heart. One-way valves in the deep leg veins keep blood flowing back towards the heart. However, prolonged periods of standing or sitting can cause the walls of the deep leg veins to stretch. Over time, in susceptible individuals, this can weaken the vein walls and damage the valves, causing blood to pool in the veins and increase venous blood pressure. This may result in a condition known as chronic venous insufficiency (CVI).

Treatment of CVI typically involves the use of compression stockings or medical hosiery to decrease chronic swelling. Compression stockings are elastic stockings that squeeze the veins to improve venous circulation and prevent excess blood from flowing backward. Compression stockings can also help to heal skin sores or stasis ulcers that often present in conjunction with CVI. It is also common to employ compression bandages to apply pressure to the leg. In this regard, a bandage is applied with constant tension so as to produce graduated compression with the highest pressure at the ankle and less pressure or compression at the knee or thigh area due to the anatomy of the leg. However, the technique is difficult and is often done by highly skilled caregivers.

Highly effective mechanical compression devices have also been developed for treating CVI, which are disclosed, for example, in U.S. Pat. Nos. 7,276,037 and 7,559,908, the disclosures of which are incorporated by reference herein in their entireties. These devices include a flexible wrap that carries a manually inflatable air bladder and is adapted to be securely positioned around the leg of an individual to apply localized pressure to a treatment site. Some of these devices also include a fluid-filled wound dressing that can be applied directly to the skin for applying localized pressure and even a medicament to a venous ulcer when it is enveloped by the flexible wrap. While these devices are effective for applying localized compression to the leg, they are not configured to apply localized compression to the calf, thigh of a user or the foot to reduce, treat or prevent swelling and to further improve venous circulation to the calf, thigh, foot or whole leg.

Lymphedema, also known as lymphatic obstruction, is another condition of localized fluid retention and tissue swelling and is caused by a compromised lymphatic system. Treatment for lymphedema varies depending on the severity of the edema and the degree of fibrosis of the affected limb. The most common treatments for lymphedema are manual compression lymphatic massage, compression garments or bandaging. Elastic compression garments are typically worn by persons with lymphedema on the affected limb following complete decongestive therapy to maintain edema reduction.

Compression bandaging, also called wrapping, involves the application of several layers of padding and short-stretch bandages to the involved areas. Short-stretch bandages are preferred over long-stretch bandages (such as those normally used to treat sprains), as the long-stretch bandages cannot produce the proper therapeutic tension necessary to safely reduce lymphedema and may in fact end up producing a tourniquet effect. During activity, whether exercise or daily activities, the short-stretch bandages enhance the pumping action of the lymph vessels by providing increased resistance for them to push against. This encourages lymphatic flow and helps to soften fluid-swollen areas.

Known methods for CVI and lymphedema treatment, like compression bandaging, have several disadvantages. The bandaging is time consuming, and the effectiveness is limited to the skill of the provider. In some instances, bandages can be applied too tightly or too loosely and may slip from their intended position, decreasing their effectiveness. When this occurs, bandages must be taken off and reapplied, further increasing the time of application and decreasing the consistency of application of the therapy. Further, when the compression bandaging is on the calf, knee or thigh area of the leg, the . . . bandaging slips down the leg when the user walks or moves around even in bed, possibly due to the anatomical shape of the thigh tapering towards the knee area and calf tapering towards the ankle area.

The effectiveness of many of the current compression therapies is limited by the application of current products. Because current compression therapy is done either with manual wraps or electromechanical systems, they require either a skilled medical processional to apply and/or the need for the patient to be stationary for extended periods of time. Although stockings and/or bandages can be worn by patients and self-administered, they are very difficult for the patient to put on and pose a challenge for unskilled medical professionals to apply consistently and effectively. Again though, the stockings and/or bandages will slip down the thigh towards the knee and down the leg towards the ankle once the user walks or moves around.

CVI and lymphedema may also result in DVT, which is an affliction that causes blood clots particularly in the lower extremities of the legs. When a patient is not ambulatory, the patient faces an elevated risk factor of creating a blood clot. These blood clots, which often accumulate or reside in the patient's calf or thigh, are not, in and of themselves, overly dangerous. However, when the blood clot breaks loose, they create a pulmonary embolism which can get lodged in the patient's heart, brain or lungs where it can cause significant damage or death. It is estimated that in each year 2 to 2.5 million Americans are afflicted by DVT causing 600,000 patients to seek medical care with 300,000 patients succumbing to the effects of the pulmonary embolism. Among people who have had a DVT, one-third will have long-term complications (post-thrombotic syndrome) such as swelling, pain, discoloration, and scaling in the affected limb. Further, about one-third (about 33 percent) of people who are diagnosed with blood clots will have a recurrence within ten years. Thus, a system and apparatus and method of use to prevent, reduce and/or treat DVT is needed which is easy to use by the patient at home, ambulatory in that the patient can work and walk about both inside and outside of the home, and less cumbersome than current known DVT systems. The number of Americans who suffer from DVT may be affected or have an increased risk based on (a) recent surgery, which decreases a patient's mobility and increases inflammation in the body, which can lead to clotting; (b) medical conditions that limit mobility, such as an injury or stroke; (c) long periods of travel, which limit mobility; (d) injury to a deep vein; (e) inherited blood disorders that increase clotting; (f) pregnancy; (g) cancer treatment; (h) smoking; (i) obesity; and (j) many other conditions. Thus, a system and apparatus and method of use to treat DVT is needed.

Many of the current treatment options for CVI and lymphedema cause venous ulcers including the use of current known devices, apparatus, bandages, stocking, hosiery and the like. A venous ulcer is damage and loss of skin above the ankle that is the result of a problem with the veins in the leg. Venous ulcers typically develop on either side of the lower leg, above the ankle and below the calf. They are difficult to heal and often recur. They also develop on the thigh, on the inner portion of the leg thigh or outer thigh area as well as near the groin area on the leg. Further, venous ulcers may develop around the knee, behind the knee, along the sides and on the front of the knee. Further it is known that ulcers or wounds on the lower leg including the foot are typically hard to treat due to the structure of the lower leg and foot and fact that the foot is moved and under pressure when walking. Conventional compression bandages, and even non-compression bandages, do not adhere to the foot, either on the top of the arch or below on the sole of the foot. Further, the foot area may become hot and moist contributing to lack of adhesion yet a diabetic foot may be extremely dry and the adhesive must be chosen not to irritate or affect the dry skin of the diabetic individual. The structure of the foot is also problematic in keeping a bandage or wound dressing in place and adhered to the foot.

Other leg ulcers such as diabetic ulcers may form on the bottom or under sole of the foot, on the toes, between the toes, on the top of the foot, on the arch of the foot and even on the ankles and heels of the foot. Diabetics may have more foot ulcers sometimes related to a complication called neuropathy that causes the individual to lose feeling in his/her/their feet. A scrape, cut or puncture in the skin can turn into an ulcer, but the individual might not know it's there if they have neuropathy and do not feel the wound or pain from the wound. Ulcers can lead to infections and in extreme cases the infection will not heal resulting in partial amputation of the individual's foot or toe(s). It is estimated that about 15% of people with diabetes in the United States will get a foot or toe ulcer and around 14% to 24% of people with diabetes in the U.S. need an amputation after they get an ulcer. Diabetic foot ulcers are the leading cause of foot amputations. As of 2020, of the estimated 537 million people worldwide who had diabetes about 19% to 34% will develop a diabetic foot ulcer in their lifetime. Unfortunately, of those individuals who develop a diabetic foot ulcer, approximately 20% of them will require lower-extremity amputation, either minor (below the ankle), major (above the ankle), or both. More than 80 percent of amputations start with a foot ulcer. Even more extreme, of those who develop a diabetic foot ulcer about 10% will die within one year of their first diabetic foot ulcer diagnosis. Further, foot and toe ulcers can happen to many people but might be more common in Black, Native American and Hispanic people. If the individual has an eye, kidney or heart disease related to diabetes, they are also at a higher risk. Of those about 15% of people with diabetes with an ulcer, the ulcer is typically on the bottom of their foot. Some of those people will be hospitalized because of complications.

Individuals are also at a higher risk of getting lower leg, foot and toe ulcers if they have any of the following conditions: blood circulation issues, heart disease, obesity, a foot condition like a bunion or hammertoe, kidney disease, and some lifestyle behaviors of using tobacco and alcohol. Thus increasing circulation of the lower leg and foot as well as preventing or reducing tissue swelling, DVT and CVI are needed for such patients and users. Further, arterial ulcers may be caused by a condition called peripheral arterial disease which reduces blood flow to your extremities. When this happens the lower leg and foot tissue may start to die. The ulcers that form from reduced blood flow are called arterial ulcers. Arteries are blood vessels that transport blood from the heart to the rest of the body, including the feet and toes. Anyone can get an arterial ulcer, but individuals who smoke or have diabetes, high blood pressure or high cholesterol are at higher risk. Thus a need exists for a therapeutic compression apparatus for the leg that treat or prevents venous and arterial ulcers on the leg or foot that has a SSI of greater than 10 to assist in increasing circulation while reducing or preventing tissue swelling and also reducing, treating or preventing lymphedema, CVI, DVT and additional ulcers, which is also easy to apply by the individual alone or by a medical professional, and improving healing times, reduces complications and assist in healing overall.

The veins of the leg are divided into the superficial and deep systems according to their position relative to the fascia. The deep veins, which come together to form the popliteal and femoral veins lie within the fascia and are responsible for the venous return from the leg muscles. Dilated valveless sinusoids also lie within the fascia (more particularly in the soleus and gastrocnemius muscles). The sinusoids fill with blood when the leg is at rest.

The long saphenous vein which runs along the medial side of the leg from foot to groin and the short saphenous vein which runs at the back of the calf from foot to knee are the major vessels of the superficial venous system. These vessels lie outside the fascia and are responsible for the venous return from the skin and subcutaneous fat. Compression on the long saphenous vein may be recommended in treatment of certain conditions whereas in other conditions there may be less compression recommendation on the long saphenous vein on the medial side of the leg and more compression recommended on the short saphenous vein of the leg which runs on the back portion of the leg, including the thigh. Communicating veins, sometimes called perforators because they perforate the deep fascia, join the two systems. The perforators, like the other veins in the leg, contain valves that permit the flow of blood in one direction only, from the outer or superficial system inwards to the deep veins.

The venous pressure at the ankle of a subject who is lying supine is around 10 mmHg, but on standing this will rise considerably due to an increase in hydrostatic pressure (equivalent to the weight of a vertical column of blood stretching from the point of measurement to the right auricle of the heart). During walking, as the foot is dorsally flexed, the contraction of the calf muscle compresses the deep veins and soleal sinuses thereby emptying them of blood. As the foot is plantarly flexed, the pressure in the veins falls, the proximal valves close, and the veins are refilled by blood passing through the perforators from the superficial system. During this cycle, in a normal leg, the distal valves of the dee veins and the valves of the perforators will ensure that the expelled blood can go in only one direction . . . upwards, back to the heart.

Blockage or damage to the venous system will cause disruption to normal blood flow, which may manifest itself in a number of different ways according to the site and extent of the damage. If the valves in the superficial system are affected, venous return will be impaired and blood may accumulate in the veins causing them to become distended, leading to the formation of varicosities (varicose veins). Such varicosities may be located in the thigh, knee, calf, ankle or foot area of the user's leg.

If the function of the perforator valves is impaired, the action of the calf muscle pump will tend to cause blood to flow in the reverse direction into the superficial system increasing the possibility of damage to the superficial vessels. Again, the current compression therapy is done either with manual wraps or electromechanical systems, they require either a skilled medical processional to apply and/or the need for the patient to be stationary for extended periods of time. A need exists for a new system to treat such medical issues. There may be minimal blood flow upward into the thigh and the rest of the body, causing issues for the patient along the body including the thigh, calf, ankle and entire leg of the patient. Thus a need exists for a compression apparatus having multiple bladders so there is compression applied to the leg either at different compression levels in different bladders or the bladders are inflated and deflated through intermittent pressure over the apparatus applying different compression levels across the leg.

Following a deep vein thrombosis that results in complete or partial obstruction of a deep vein, the unrelieved pressures produced by the calf muscle pump on the perforator valves may cause these to become incompetent. If this occurs, there will be a large rise in the pressure in the superficial system, which may force proteins and red cells out of the capillaries and into the surrounding tissue. Here, the red cells break down releasing a red pigment that causes staining of the skin, an early indicator of possible ulcer formation. The ulcer formation can be in any part of the body, including the leg, groin, thigh, knee, calf, ankle and foot.

Venous leg ulcers are generally shallow and red in color. The skin surrounding the ulcer is frequently discolored due to the staining described previously. Incompetent perforating vein valves can also cause malleolar venules to become dilated and appear as fine red threads around the ankle as well as the thigh, knee, calf or foot are of the leg or any area of the leg. This condition, called ankle flair, is also diagnostic of a venous ulcer. The condition may also be seen on the thigh, including the inner medial thigh area or outer lateral thigh area, or around the knee or groin area of the patient's body.

Arteries transport oxygen replenished blood from the heart to the rest of the body. Veins return oxygen depleted blood back to the heart. When the veins in the lower extremities of the body have difficulty transporting blood back to the heart, a condition develops called chronic venous insufficiency (CVI), also known as chronic venous disease (CVD). CVI most commonly occurs as the result of a blood clot in the deep veins of the legs, a disease known as deep vein thrombosis (DVT). CVI also results from pelvic tumors and vascular malformations, and sometimes occurs for unknown reasons. When a person is standing or sitting, blood in the veins of the legs flows in an upward direction. When the person walks, the calf muscles and muscles in the feet contract to squeeze the veins and push the blood upward. To keep the blood flowing upward and prevent it from flowing downward, the veins contain one-way valves. CVI occurs when these valves become damaged and allow the blood to leak back downward in the opposite direction. Such valve damage may occur as the result of aging, extended sitting or standing, or a combination of aging and reduced mobility. When the veins and valves become weakened and the blood does not properly flow up to the heart, blood pressure in the veins of the lower extremities can stay elevated for long periods of time, leading to CVI. This condition is more common in older individuals, and if not properly treated, can lead to burst capillaries, local tissue inflammation, internal tissue damage, varicose veins, ulcers, and open sores on the skin's surface. The burst capillaries can be seen on the patient's leg including the thigh, knee and groin.

CVI can diminish the capacity of the venous system and increase the workload of the lymphatic system in the affected area. The lymphatic system must then transport larger volumes of water and protein to reduce the fluid load in the affected tissues of the legs, a situation which is especially difficult for patients with lymphedema, varicose veins, and other lower extremity pathology.

One non-surgical option often used to help prevent or treat the leg extremity pathologies discussed above is the use of compression stockings. Compression stockings help prevent leg fatigue, ankle and foot swelling, spider veins, and varicose veins. They improve circulation in the legs, especially when used in conjunction with frequent exercise and leg elevation. Compression stockings maintain pressure on the legs while allowing for normal ambulation. Increasing pressure in the tissues beneath the skin reduces excess leakage of fluid from the capillaries and increases absorption of tissue fluid by the capillaries and lymphatic vessels. In addition, the increased pressure decreases the size of the veins, which causes the blood to flow faster and helps prevent it from pooling. Compression stocking tightness typically varies between 15-50 mm HG. The tightness of a given stocking depends on its particular configuration- and class. For example, stockings having a compression pressure of 15-20 mm HG are considered light compression stockings. Class I stockings are 20-30 mm Hg, class II stockings are 30-40 mm Hg, and Class II stockings are 40-50 mm Hg.

While such compression stockings are a commonly utilized non-invasive treatment of leg pathology, the issues they present are numerous. Wearing a tightly fitting stocking can be tedious or time consuming to put on, and may require help from another person if the wearer is injured, elderly, or has some form of disability. Any tight-fitting stocking to be worn on the lower leg has to be put on by the user over the foot, ankle and up the calf while placing a tight fitting stocking on thigh area has a harder time being put on as the user has to pull the tight-fitting stocking over the foot, ankle, calf, knee and finally up to the thigh area. Again, due to the shape of the calf and thigh, these tight-fitting stockings will slip down the leg at some point due to the user walking or moving about.

In addition, the pressure applied by the stocking generally stays relatively constant during use without any option of increasing or decreasing the tightness level. As compression stockings are repeatedly worn, they lose elasticity and thus tightness over time. Once such prescribed elasticity and tightness is lost, the stocking is of little or no value, and needs to be replaced on account of its looseness, which requires buying a new pair to obtain the desired pressure. Further, given the shape of the thigh, the top or upper portion of the stocking must be very tight in order to prevent slippage down the thigh, which can in turn lead to complications of its own due to the excessive tightness.

Medical hosiery represents a useful and convenient method of applying compression to normal shaped legs in order to prevent the development or recurrence of leg ulcers. However, these stockings are of limited value in the treatment of active ulceration, being difficult to apply over dressings. In such situations compression bandages currently represent the treatment of choice. Compression bandages apply a pressure to the limb that is directly proportional to bandage tension but inversely proportional to the radius of curvature of the limb to which it is applied. This means, therefore, that a bandage applied with constant tension to a limb of normal proportions will automatically produce graduated compression with the highest pressure at the knee. This pressure will gradually reduce up the thigh as the circumference increases.

As can be readily appreciated, it is cumbersome and difficult to apply uniform tension to the compression bandage as it is applied to the treated limb, and this is accomplished only by highly skilled caregivers. Moreover, once secured to the treated limb, care and attention must be given to ensure that the bandage does not slip or become displaced as this will lead to multiple layers forming, which in turn may lead to localized areas of high pressure, which can place the patient in direct risk of skin necrosis.

Mechanical compression treatments have also been proposed. An exemplary compression device is described in U.S. Pat. No. 5,031,604 to Dye. As generally described at col. 2, lines 33 et seq., an arrangement of chambers are provided that circumscribe the leg. An active pneumatic control system controls the pressure in the chambers to squeeze the leg near the ankle and then squeeze sequentially upward toward the knee in order to move blood from the extremity toward the heart. As noted in col. 4, lines 20-59 of U.S. Pat. No. 6,488,643 to Tumey et al., the mechanically produced compression levels may produce ischemic (i.e., localized tissue anemia) not noted at similar compression levels obtained through bandaging. It may also produce cuffing (i.e., a reduction in leg pulsatile blood flow). The pneumatic control system is also bulky and heavy, which severely limits the mobility of the patient during treatment. Moreover, the pneumatic control system fails to provide a mechanism to ensure that excessive pressure, which can cause necrosis, is not applied to the treated limb. These limitations have resulted in most mechanical compression devices being contraindicated for patients exhibiting DVT. Consequently, those skilled in the art have to date avoided such mechanical compression devices for the treatment of venous ulcers or edema of the extremities.

DVT is widely recognized as a major risk factor facing patients who undergo total hip arthroplasty (THA) and total knee arthroplasty (TKA). Without prophylaxis (preventive treatment), up to 80 percent of orthopedic surgical patients will develop DVT, and 10 to 20 percent will develop a pulmonary embolism (PE). Even when proper prevention measures are taken, it is estimated that 3 percent of orthopedic surgical patients will develop DVT, and 1.5 percent will develop PE. DVT and PE remain the most common cause for emergency re-admission and death following joint replacement surgeries. In one survey conducted the patients surveyed after a THA or TKA stated problems with their prophylaxis varied widely: 83 percent reported issues with lack of ambulation, 74 percent used compression stockings, 57 percent used mechanical compression, 58 percent used an anticoagulant pill, 46 percent used an anticoagulant injection, and 42 percent used aspirin. (https://www.stoptheclot.orn/about-clots/toolkir-for-knee-hip-replacement-patients/orthopedic-surgery-fact-sheet/). Thus, a need exists for a prophylaxis which is easy for the patient to use at home or work (outside a hospital setting or with the aid of a medically trained professional as noted above) which is ambulatory so that the patient can walk and return to life activities.

Knee replacements may also result in DVT as a post-operative complication. After knee surgery, most DVTs occur in the calf. Although less likely to lead to a PE, these clots are more difficult to detect. Less than one third of patients with DVT present with the classic signs of calf discomfort, edema, distended veins, or foot pain. It has been noted that the risk of developing DVT extends for at least three months after a total knee replacement. The risk is greatest two to five days after surgery; and a second peak development period occurs about 10 days after surgery. Currently, it has been noted that patients at home are experiencing an increase in DVT due to lack of activity and movement. While the patient is in the hospital, he or she may be connected to an electrical powered pump in combination with an inventive therapeutic compression apparatus, however, once discharged, the current products are limited as noted herein, whereby most inventive therapeutic compression apparatus are manual pumped so the patient can walk, work, etc. and those that are electric powered typically require being tethered to an electric outlet or the electric pump is integral to the inventive therapeutic compression apparatus and not practical to walk about in life. Thus a need exists for a system which can be used to prevent, reduce or even treat DVT and reduce the risk of PE which is practical to use, mobile and easy to be administered by the patient post-operative total knee replacement of any other knee, hip or leg surgery. A need exists so that the user can walk around with the compression profile maintained while not being limited to an electrical plug or some other separate source of continued, maintained or even increased then decreased compression. A need exists for an integrated valve or other means in the compression garment, wrap, device or apparatus to maintain the set compression.

Further compression treatments have been discussed in “Effect of High-pressure, Intermittent Pneumatic Compression for the Treatment of Peripheral Arterial Disease and Critical Limb Ischemia in Patients Without a Surgical Option”, by Oscar M. Alvarez, Martine E. Wendelken, Lee Markoqitz and Christopher Comfort (Wounds, Vol. 27, Issue 11, pages 293-301, November 2015) wherein thirty-six patients with symptomatic peripheral arterial disease (PAD) or critical limb ischemia (CLI) who were experiencing claudication pain, chronic resting pain, numbness, and ischemic lower leg/foot ulceration were randomized into 2 treatment groups. Eighteen of these patients received treatment with high-pressure, intermittent pneumatic compression (HPIPC) 60 minutes twice daily for 16 weeks, and 16 subjects received standard care consisting of an exercise regimen of walking for 20 minutes twice daily for 16 weeks. The HPIPC device delivers bilateral pressures of 120 mm Hg. Cycle times provide sequential compression for 4 seconds (+/−0.5 seconds) followed by a 16-second rest period (+/−3.0 seconds), resulting in a 20-second cycle or 3 cycles per minute. The study was designed to measure patient-centered outcomes. The primary endpoint was peak walking time (PWT), defined as time to maximally tolerated claudication pain. The conclusion at the end of the study was that therapy consisting of HPIPC for 2 hours daily for a period of 16 weeks significantly improved PWT, reduced resting pain, and improved healing rates, physical function, and bodily pain. There were no device related complications, allowing for long-term use. A further conclusion was that HPIPC offers an excellent alternative for the palliative care of patients with PAD and CLI symptoms. Thus, a need exists for a system which can be easily administered by a patient in the home setting which includes HPIPC.

Co-owned U.S. Publication No. 2004/0193084, which is hereby incorporated by reference herein in its entirety, discloses a device for applying pressure to the human leg for use in conjunction with treatment of varicose veins. The device includes a flexible member and at least one air bladder chamber integral thereto that are adapted to securely wrap around the human leg. A tube in fluid communication with the air bladder chamber(s) extends to an air pumping mechanism that operates to inflate the air bladder chamber(s) to a pressurized state. The flexible member preferably includes an opening at the knee joint level to enable a patella to protrude therethrough. In addition, the flexible member preferably extends below knee joint level and is adapted to securely wrap around a lower portion of a leg to provide stability to the leg. Preferably, the air bladder chamber of the device is substantially longer in a first dimension than in a second dimension orthogonal thereto such that the air bladder chamber can be positioned to cover a portion of the human leg that is relatively long in the vertical dimension and narrow in the horizontal dimension.

Co-owned U.S. Pat. No. 7,276,037, which is hereby incorporated by reference herein in its entirety, discloses an apparatus for applying compression therapy to an extremity of the human body, such as a portion of the human leg. The device includes a flexible member and an air bladder chamber. The flexible member is adapted to wrap around the extremity to secure the air bladder chamber to the extremity. An air pumping mechanism is operated to inflate the air bladder chamber to a pressurized state. One or more fluid-filled pressurized members are provided, each separate and distinct from the flexible member and the air bladder chamber and thus readily moveable relative to the flexible member and the air bladder chamber. The pressurized member(s) is operably disposed between the extremity and the flexible member whereby it applies increased localized pressure to the extremity during use. Preferably, the air bladder chamber is substantially longer in a first dimension than in a second dimension orthogonal thereto such that it can extend longitudinally along the extremity to cover a relatively long and narrow portion of the extremity. The position of the air chamber can be readily adapted to apply local pressure to desired body parts (such as a certain venous channel). The pressurized member(s) can be positioned during use such that it covers a venous ulcer (or other treatment sites) and applies increased localized pressure to the treatment site in order to promote healing.

One way of measuring the compression efficacy of a therapeutic apparatus is the Static Stiffness Index (SSI). The Static Stiffness Index (SSI), which is the difference between standing and resting pressure, is a valuable parameter characterizing the efficacy of a specific compression product to narrow/occlude the venous lumen. This is a prerequisite for reducing venous reflux and exerting a massaging effect necessary to improve the venous pumping function during movement. Anything above 10 SSI is considered “inelastic”. Most if not all current inventive therapeutic compression apparatus have a SSI or about 2-12, with the inelastic apparatus having a SSI of about 10-12. A need exists for a therapeutic compression apparatus with a SSI of at least 10 and above. The higher the SSI then the better the compression at the target limb site. Higher SSI means the level of compression is comfortable relatively speaking vascular push and not constricting blood if higher SSI.

While needing a compression level greater than 10 SSI is beneficial, a need further exists for a therapeutic compression apparatus which also includes multiple inflatable bladders that can be sequentially inflated and deflated such as intermittent compression and/or can be inflated at different . . . levels of pressure and compression.

Sequential compression or having multiple bladders with different compression or pressure levels would be beneficial for patients having sclerotherapy which is a medical procedure used to eliminate varicose veins and spider veins. Sclerotherapy typically involves an injection of a solution (generally a salt solution) directly into the vein. The solution initiates the lining of the blood vessel, causing it to collapse and stick together and the blood to clot. Post-operative procedures may require compression bandaging or stockings, both of which have the problems described above in regard to static compression over the target limb area.

In general the known compression devices may include an inflation means capable of providing constant static pressure for a period of time as well as providing intermittent varying pressure for a period of time, but the currently known devices are bulky as the inflation means or pump is an integral part of the wrap mechanism. Such known compression devices are limiting as the patient cannot walk or function in work, school or otherwise wearing bulky leg, foot, thigh or other limb wrap. Further, certain known compression devices only allow for varying intermittent pressure if directly connected to an electrical power source, thereby further limiting the use by the patient as he or she is literally tethered to a wall outlet. Moreover, known compression devices or apparatus lack a check valve to prevent both over-inflation and to also seal and prevent deflation while the user engages in activities or rests in place. A need exists for a therapeutic compression system including a compression apparatus having multiple bladders sequentially inflated and deflated or inflated to different compression or pressure levels and having an integrated valve to maintain the level of compression and prevent deflation of a bladder, and preferably a self-sealing valve.

Further, sequential compression may assist in therapies for lymphedema, CVT, CVI, DVT and the like. Having multiple bladders within a compression apparatus is known but a need exists for a streamlined inflation means to feed each bladder and a controlling mechanism so that each bladder is inflated sequentially. Another need exists for a separate foot bladder from the lower leg bladder and/or the upper leg or thigh bladder, so that each bladder has a separate compression level, and again, coordinated sequential compression or pressure when inflated. Further a need exists where each of the separate bladders has a SSI of at least about 12 or greater.

A need exists for a system in which a compression garment includes a universal connector to a variety of pumps. Thus, the user could interchange between an intermittent pneumatic pressure pump, for instance when seated, and then change to a set pressure pump for instance when walking. The user could connect to a hand pump, an electrical pump, a mechanical pump and any other type of conventional or inventive pumps without any additional converted needed. The various types of pumps are not limited to the two listed above but could be any type of pump with a universal connector.

Further a need exists for a system including an inflation means which can inflate multiple inventive therapeutic compression apparatuses at the same time. Another need exists for a system including an inflation means which means can switch between a constant static pressure level and an intermittent varying pressure level. The inflation means is also configured to provide constant static pressure for a period of time as well as varying intermittent pressure for a period of time and to alternate between such pressure settings.

A further need exists for a system including an inflation means which is less bulky than known systems. The user can thus return to life activities sooner than with known compression systems, prophylaxis systems and other treatment systems which limit the user's ambulation both within and outside the home due to power constraints (electrical, mechanical, battery, manual, etc.) on the system. Further a need exists for an inelastic compression apparatus or wrap that anatomically fits the target limb such as the lower leg, calf, full leg, knee, thigh, arm, torso or any other limb.

An additional need exists for a system including one or more sensors to measure the user's limb in regard to pressure on the skin, motion of the limb, blood pressure, tonometer sensor, GPS sensor, and the like while the system is in use. Such sensors may be connected to the inflation means so as to regulate the pressure from the inflation means and either increase or decrease the current pressure level(s). Such sensors may also be connected to a database and possibly accessible to a medical professional and/or the user in real time or as saved over time.

A need exists for a system of multiple of compression garments have separate active pressures. For instance, a thigh compression garment could be used in conjunction with a lower leg compression apparatus such as that described (and incorporated herein as reference) in U.S. Pat. Nos. 9,033,906 and 7,967,766 and 7,559,908 and U.S. Ser. No. 13,444,600 and U.S. Ser. No. 16/328,718 and therefore the user could wear two separate inventive therapeutic compression apparatus on the entire leg and could also include an optional knee wrap. In this instance the user could have one pressure level on the inventive thigh inventive therapeutic compression apparatus whereas a calf compression garment could have a second pressure level and both compression garments are connected to one pneumatic pump configured to have multiple pressure outlets. Such a need exists for such a system.

All current known treatment apparatus, devices, bandages, stockings and hosiery have the problems of stability (no slippage), maintaining sufficient effective pressure without overpressure complications, maintaining compression and the like. Further all known apparatus, devices, bandages, stockings and hosiery, though especially the current treatment inelastic apparatus and devices are only capable of a SSI of no higher than about 10-12 so that a need exists for a therapeutic compression apparatus having a SSI of above about 10, preferably about 15-25.

The subject invention provides an alternative to known technologies that employ tight-fitting therapeutic elastic garments, which cause patients discomfort and are bulky and impractical to wear in daily life, and lose their elasticity as well as have slippage down the leg, and therefore their effectiveness over time as well as inelastic garments and apparatus with a SSI of less than about 10-12. Those skilled in the art will readily appreciate that it would be beneficial to provide a therapeutic compression device and system for treating CVI, DVT, lymphedema and tissue swelling that is adapted and configured to apply localized compression to the leg, thigh, calf and/or foot to prevent swelling and further improve venous circulation, that may also be self-administered by a patient effectively, and have a sufficient SSI of about greater than 10, preferably about 15 to about 35. Other body parts may also be such to compression such as the arm, wrist, torso, shoulders and the like

Without limitation, the inventive therapeutic compression system having multiple bladders may be used with any required compression therapy, such as venous disease, vascular disease, lymphedema, post-operative (such as but not limited to TKR, KRA, HRA, TI-IR and sclerotherapy, etc.) and the like. The inventive therapeutic compression system may be used to treat any general swelling as well as being used post operatively, for example including in cases of sclerotherapy or vein ablation. The inventive therapeutic compression system having multiple bladders may be used also by a person for compression therapy such as athletes and lactic acid build up, or pregnant women, as well as any individual who walks a lot or is on their feet at work for period of time. Other uses for the inventive system may be envisioned.

### SUMMARY OF THE INVENTION

The subject invention is directed to a therapeutic compression system and methods of use. The therapeutic compression system includes one or more compression apparatus each having at multiple bladders and depending on target limb may have two, three or more bladders, all connected to one inflation means and each apparatus having a check valve in an inflation port on the apparatus capable if maintaining the pressure within he inflated bladder when the inflation means is disconnected to the apparatus. Each inventive therapeutic compression apparatus has a SSI of at least about 10 or greater. The therapeutic compression system includes a therapeutic compression apparatus and an inflation means wherein the inflation means is less bulky than known inflation means. The inflation means includes at least two settings, a setting of constant inflation or pressure and a setting of varying or intermittent inflation or pressure. The inventive therapeutic compression system may include at least one sensor, such as a motion sensor, pressure sensor, blood pressure sensor, tonometer sensor, or other sensors to monitor use of the inventive system by the patient and/or medical professionals.

The system includes different inventive therapeutic compression apparatus such as but not limited to an apparatus for use on a leg, calf, thigh, hip, pelvis, knee, foot, torso, arm, neck or other body parts.

The therapeutic compression system includes an inventive therapeutic compression apparatus which such apparatus may further comprise at least one bladder operatively associated with the inventive therapeutic compression apparatus for applying pressure to a treatment site on the limb such as a leg having a SSI of at least about 10 or above. The inventive therapeutic compression apparatus includes a connecting means such as a loop and hook material in order to wrap the inventive therapeutic compression apparatus around the limb, such as a leg, of the user. Alternatively, the at least one bladder may be integral with the connecting means or wrap and depending on the target limb may have at least two or at least three separate bladders within the apparatus. One or more connecting means may be operatively associated along the first and second peripheral edges of the inventive therapeutic compression apparatus for securing it around the limb.

The multiple bladders may be adapted and configured to form a predetermined gradient compression profile and/or gradient pressure profile when the bladders are filled. The gradient compression profile and/or gradient pressure profile may be determined by the location of various spot welds on the bladder to create the gradient compression profile and/or gradient pressure profile and when inflated the inventive apparatus has a SSI or at least about 10 or greater. The gradient compression profile and/or gradient pressure profile instead may be determined by the inflation means connected or integral to the inventive therapeutic compression apparatus. In another embodiment, the gradient compression profile and/or gradient pressure profile may be determined by pressure being created in one direction within the bladder by the inflation means and then exiting the bladder through an exhaust port or other exit means. The at least one bladder may be one of a wedge-shaped bladder, a cone-shaped bladder, a disk-shaped bladder or a rectangular-shaped bladder. The at least one bladder may also include a plurality of fluid chambers. The inventive therapeutic compression apparatus, as part of the inventive system, may further comprise at least one means for adjusting pressure coupled to the at least one bladder for controlling an amount of pressure supplied to the treatment site. In an apparatus with more than one bladder, each bladder is connected to the same inflation means and the inflation means sequentially inflates each bladder, which could be the same or different pressure levels, and once disconnected a check valve within an inflation port on each separate bladder maintains the then current pressure level.

The inventive therapeutic compression apparatus may include an inelastic portion and an elastic portion, such as on the upper portion of the at least one bladder when worn on a lower leg, such as around the upper calf area of the limb. The elastic portion may be located near the elbow, wrist or shoulder of a user when placed on the arm limb. The elastic portion may be located at the groin area of the user when placed on the thigh or lower torso or hip or buttocks area of the user. Other locations may be employed depending on the limb being subject to the therapeutic compression system on the user.

The subject inventive therapeutic compression apparatus for providing pressure to a limb including a bladder assembly. The bladder assembly comprises: at least one bladder having first and second flexible walls secured to one another about a peripheral edge thereof to form an air pocket; and at least one spot weld provided in a predetermined location inward of the peripheral edge connecting the first and second walls to one another to define a plurality of chambers within the bladder. The geometric placement of the at least one spot weld determines a compression profile and/or pressure profile of the at least one bladder in one embodiment. The pressure profile and/or compression profile may be a gradient pressure profile and/or a gradient compression profile. The bladder assembly when inflated has a SSI of at least about 10 or greater. The top portion of the bladder assembly is adjacent to an elastic portion which may provide a tighter fit to the user when the entire inventive therapeutic compression apparatus is worn on the user's target limb.

An inflation means for inflating the bladder such as the air pocket through at least one inflation port may be provided in the first wall of the bladder assembly. The inflation means may be detachable from the at least one inflation port. At least one pressure valve may be operatively associated with the inflation means for controlling an amount of pressure within the bladder and the air pocket within the bladder. The inflation port includes a check valve so as to maintain a given pressure within the bladder of the inventive therapeutic compression apparatus. The inflation port may be universal in that it is configured to be capable of connecting to and accepting a plurality of inflation sources and inflation means such as a manual pump, mechanical pump, electrical pump, battery-operated pump, static pump, intermittent pump, pneumatic pump, negative pressure source and other variations. Where there are more than one bladder within the apparatus, each bladder is sequentially inflated, and may be sequentially deflated and repeated on and on, or the pressure may be maintained once the inflation means is disconnected to the inflation port located on each separate bladder.

The bladder is connected to an inflation port including a valve configured so that when the valve is in the closed position the pressure profile and/or compression profile is maintained at the then current pressure and/or compression level. The valve is configured so that when it is in the open position the fluid, such as air, flows from the inflation means into the bladder and if not connected to an inflation means then the fluid escapes from the bladder and it is deflated. The valve may be self-sealing or itmay be connected to a means to open and close it with for example a level, knob, screw or other opening and closing means.

A method of the invention includes the therapeutic compression system including a therapeutic treatment apparatus used to treat CVI, DVT, tissue swelling, arterial and/or venous ulcers, and/or lymphedema by applying the primary and secondary wraps around a limb by a patient and inserting an inflation means into an inflation port and inflating the bladders within the primary and secondary wraps and maintaining a certain pressure to treat the CVI, DVT, tissue swelling, arterial and/or venous ulcers and/or lymphedema and having a SSI of at least about 10 or greater when inflated.

Another embodiment of the present invention includes an assembly according to the invention includes a pressure mechanism having a flexible member for attachment to a limb and an air chamber which may be pumped up into a desired pressurized state, a separate relatively small pre-filled air bladder, an absorbent foam, sponge or dressing coupled to the pre-filled air bladder, and a suction conduit coupled to a source of negative pressure (suction) and in fluid communication with the absorbent foam, sponge or dressing. In a preferred embodiment, the pre-filled air bladder, the absorbent foam, sponge or dressing and the suction conduit are formed together as a unit.

According to one aspect of the invention, the flexible member of the pressure mechanism is adapted to wrap around a leg or arm and over the pre-filled air bladder in order to secure the pre-filled air bladder and the foam, sponge or dressing to a wound or ulcer in the extremity. Thus, the flexible member is provided with some fixation structure such as a hook and loop closure mechanism. An air pumping mechanism is preferably coupled to the air chamber of the pressure mechanism in order to inflate the air chamber to a pressurized state. The air chamber of the pressure mechanism is designed to apply pressure along a predefined area (e.g., the saphenous vein of a leg) as opposed to around an entire limb.

According to another aspect of the invention, the suction conduit is located either between the pre-filled air bladder and the absorbent foam, sponge or dressing which is adhered to the small air bladder, or the pre-filled air bladder is formed as a donut with a central opening and the suction conduit extends through the central opening. By coupling the suction conduit to a source of negative pressure, exudate from the wound or ulcer is sucked through the foam, sponge or dressing into the suction conduit.

One of the methods of the invention include locating the pre-filled air bladder and foam, sponge or dressing over a wound or ulcer on a limb, wrapping the flexible member of the pressure mechanism around a limb with the air chamber located over the pre-filled air bladder/absorbent foam, sponge or dressing, and fastening the pneumatic pressure mechanism in place with the fixation structure. When the apparatus is properly located and affixed to the limb, the air chamber is inflated, preferably to 30-40 mm Hg, thereby applying pressure to the limb and more specifically via the pre-filled air bladder to the wound. The suction apparatus is activated by turning on the source of negative pressure, and exudate from the wound or ulcer is pulled through the absorbent foam, sponge or dressing into the suction conduit.

Another embodiment of the present invention includes a system including an apparatus for applying intermittent pressure to a portion of the human body, such as an area of the human leg, which assists with the healing and treatment of various conditions such as venous ulcers or wounds by promoting blood flow into and out of the area and by increasing drainage. The apparatus may include a thigh bladder or a foot bladder and a leg bladder, each having inflatable chambers (at least one and possibly two or more bladders within each apparatus) that accommodate an entering fluid by inflating. The bladders are fluidly coupled by a fluid conduit, and each is preferably equipped with a means for locating it on a portion of the body. In a preferred embodiment, the thigh bladder is positioned between the pelvis or groin or hip area of the user and the knee of the user. As a person walks while wearing the apparatus, a portion of the thigh bladder deflates as the person's leg moves foot (heel) strikes the ground due to the external pressure placed on the foot bladder, thereby forcing fluid out of the foot bladder, through the fluid conduit, and into the leg bladder, which raises the pressure therein. As the person's foot rolls from heel to toe in the standard walking motion, the external pressure from the person's weight is removed from the foot bladder, resulting in the pressure of the leg bladder being higher than the pressure in the foot bladder. Fluid thus flows back through the fluid conduit and into the foot bladder, which then inflates again to its original state, such that the pressures of the foot bladder and leg bladder are equalized. This process repeats as a person walks, thereby creating a pumping or kneading force on the leg as the pressure in the leg bladder intermittently increases and decreases, thereby promoting blood flow, fluid drainage, treatment, and healing to various parts of the leg.

In one embodiment of the present invention, the therapeutic compression system includes an inflation means connected to a belt so the user can wear it around his or her waist in daily use, such inflation means may be connected to the inventive therapeutic compression apparatus by, for example, a hose or a tube, which provides inflation to the bladder within the inventive therapeutic compression apparatus and/or wrap.

In another embodiment of the present invention, the therapeutic compression system includes an inflation means which can switch between constant static pressure levels (different pressure levels such as 20 mm-Hg, 30 mm-Hg, 40 mm-Hg, up to 200 mm-Hg, etc.) and intermittent varying pressure levels, whereby the pressure is applied to the inventive therapeutic compression apparatus via a hose or tube. The inflation means may be capable of sequentially inflating each bladder separately, and then deflating, or repeating the inflation and deflation as required.

In other embodiments the inflation means is connected to two or more tubes and thereby connected to two or more bladders, whether multiple bladders within one inventive therapeutic compression apparatus or a single bladder within multiple inventive therapeutic compression apparatuses, or a combination thereof. In another embodiment the inflation means includes one pump with a manifold having multiple chambers each corresponding to a bladder within the apparatus or multiple apparatus, such that the inflation means connected to the manifold is connected to multiple hoses which then connected to each separate bladder, for sequential inflation and deflation of each separate bladder.

In another embodiment the system includes one or more sensors to monitor movement of the inventive therapeutic compression apparatus, pressure levels, blood pressure of the patient, tonometry of the target limb, or other sensor data.

These and other aspects of the contacts of the subject invention will become more readily apparent from the following description taken in conjunction with the drawings.

### BRIEF DESCRIPTION OF THE DRAWINGS

So that those having ordinary skill in the art to which the subject invention pertains will more readily understand how to make and use the apparatuses of the subject invention, preferred embodiments thereof will be described in detail herein below with reference to the drawings, wherein:

FIG. 1 is a view of one embodiment of the present invention including a lower leg inventive therapeutic compression apparatus connected to a tube connected to an inflation means located on a retaining means such as a belt;

FIG. 2 is another embodiment of the present invention in use on a person including two lower leg inventive therapeutic compression apparatuses each connected to a tube and a thigh inventive therapeutic compression apparatus, all three tubes connected to one inflation means located on a retaining means such as a belt;

FIG. 3 is an exploded view of the embodiment of the belt, inflation means and battery pack as seen in FIGS. 1 and 2;

FIG. 4A is a cut away view of the inflation means of FIG. 1 showing the sensor port and one inflation port, both connected to one tube which inflates and deflates the inventive therapeutic compression apparatus.

FIG. 4B is a cut away view of the inflation means of FIG. 2 showing the sensor port and three inflation ports, all connected to a tube which inflates and deflates all three inventive therapeutic compression apparatus or three separate bladders within one or more therapeutic apparatus, or in the alternative could be connected to at least three tubes may be connected to three separate bladders within one inventive therapeutic compression apparatus or the three tubes could in the alternate be connected to at least three separate inventive therapeutic compression apparatus, or a combination thereof.

FIG. 5A is a cut away view of the inflation port of FIGS. 1 and 2 showing one embodiment of the self-sealing check valve in the-open position as the bladder is being inflated;

FIG. 5B is a cut away view of the inflation port of FIGS. 1 and 2 showing one embodiment of the self-sealing check valve in the closed position to prevent deflation of the bladder once inflated;

FIG. 6 is a further embodiment of an inventive therapeutic compression apparatus wherein the inflation means is connected to an intake port and to a separate exhaust port of such inventive therapeutic compression apparatus;

FIGS. 7A-7E are embodiments of the flow representation of the methods of use of the inventive system including a lower leg inventive therapeutic compression apparatus and a thigh inventive therapeutic compression apparatus;

FIGS. 8A-8K are yet another embodiment of the flow representation of the method of use of the inventive system including a lower leg inventive therapeutic compression apparatus.

FIG. 9 is yet another embodiment of the present invention including three separate inventive therapeutic compression apparatus (foot, lower leg and thigh) configured to connect to one inflation means via a manifold in a inflation means, with the lower leg apparatus including three separate bladders and the thigh apparatus including two separate bladders, and a sock below the foot and lower leg apparatus;

FIG. 10 is yet another embodiment of the present invention including three separate inventive therapeutic compression apparatus (foot, lower leg and thigh) configured to connect to one inflation means via a manifold in a inflation means, with the foot and lower leg apparatus only having one bladder each and the thigh apparatus including two separate bladders, and a sock below the foot and lower leg apparatus;

FIG. 11 is yet another embodiment of the present invention including three separate gradient inventive therapeutic compression apparatus (foot, lower leg and thigh) configured to connect to one inflation means via a manifold in a inflation means, with the lower leg apparatus including three separate bladders and the thigh apparatus including two separate bladders, each bladder configured with a gradient compress profile;

FIG. 12 is another embodiment of the present invention including a manifold connected to or integral with the inflation means capable of separately and sequentially inflating each of the separate bladders in the one or more inventive therapeutic compression apparatus via a switch or valve connected to a hose or tube further connected to a respective universal inflation port(s) on each of the apparatus;

FIG. 13 is yet another embodiment of the present invention including two separate inventive therapeutic compression apparatus (foot and full leg) with an elastic knee portion connecting the upper and lower leg portions of the full leg apparatus, and a sock below the foot apparatus and lower leg portion of the full leg apparatus;

FIG. 14 is another embodiment of the present invention of FIG. 1 with two separate bladders within the lower leg inventive therapeutic compression apparatus, two inflation ports, two hoses, and two connectors to the manifold and inflation means;

FIG. 15 is another embodiment of the present invention of FIG. 1 with three separate bladders within the lower leg inventive therapeutic compression apparatus, three inflation ports, three hoses, and three connectors to the manifold and inflation means;

FIG. 16A-C is another embodiment of the present invention of a separate foot inventive therapeutic compression apparatus capable of connecting to the one inflation means connected to other apparatus, with FIG. 14A showing the front view, FIG. 14B showing the back view and FIG. 14C showing the side perspective view;

FIG. 17 is an exploded view of FIG. 16;

FIG. 18 is a top view of yet another embodiment of the foot inventive therapeutic compression apparatus of the present invention, as well as a toeless short sock under the foot inventive therapeutic compression apparatus;

FIG. 19 is yet another embodiment of a thigh inventive therapeutic compression apparatus having two separate bladders, in an exploded view of the apparatus;

FIG. 20 is yet another embodiment of the present invention including a perspective view of a lower leg inventive therapeutic compression apparatus having two separate bladders (upper calf and lower calf with foot) capable of connection to the same inflation means, with the apparatus including an elastic portions at the upper calf, and with a sock or sleeve connected to the lower leg inventive therapeutic compression apparatus;

FIG. 21 is yet another embodiment of the present invention including a perspective view of a lower leg inventive therapeutic compression apparatus having three separate bladders (upper calf, lower calf and foot) capable of connection to the same or different inflation means, with the apparatus including an elastic portion at the upper calf, and with a sock or sleeve connected to the lower leg inventive therapeutic compression apparatus; and

FIGS. 22A-C is another embodiment of the present invention including two different variation of the manifold having apertures for insertion of a connecting means on the hoses (FIGS. 22A and 22B) and yet another embodiment of the present invention of the inflation means connected to the manifold having four hoses connected within the manifold.

### DETAILED DESCRIPTION OF THE PREFERRED EMBODIMENTS

Preferred embodiments of the subject invention are described below with reference to the accompanying drawings, in which like reference numerals represent the same or similar elements. One of ordinary skill in the art would appreciate that while the apparatuses discussed herein relate to compression therapy of the leg and foot, the scope of the invention is not limited to those exemplary applications and may be sized and shaped for the anatomical portion for which compression therapy is needed.

The subject invention provides compression to a patient's limbs, including the extremities, including for example, the leg of a user and more specifically the thigh of a user, in a manner that is simpler, less bulky, more practical, more mobile, and more convenient than current systems. Any limb or body part may be compressed by the instant system including an inventive therapeutic compression apparatus such as for instance a foot, calf, thigh, knee, leg, hip, buttocks, waist, torso, ribs, shoulder, arm, band, fingers, neck, head or the like.

The subject invention provides system for providing compression and preventing swelling of a limb such as for instance the leg using a non-elastic binder and bladder which can be used for compression, which apparatus has at least one and preferably more than one separate bladders within the apparatus, and is connected to an inflation means including a dual means having both constant static pressure levels and varying intermittent pressure levels and the bladders are inflated sequentially. The system is provided in in a manner that allows for consistent measuring of the pressure supplied, as well as safe, comfortable, more practical, more mobile, convenient, effective, and self-application by the patient.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” would include a plurality of such stimuli and reference to “the signal” would include reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates, which may need to be independently confirmed.

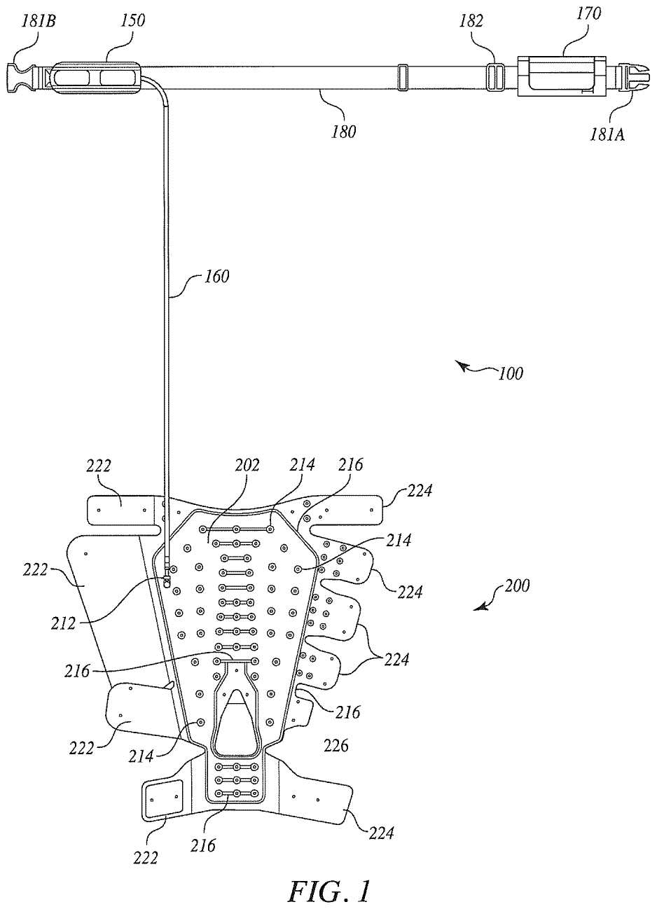

Referring now to FIG. 1, there is illustrated an exemplary embodiment of the inventive system 100 including an inventive therapeutic compression apparatus 200, an inflation means 150 and a connecting means 160. In some embodiments the inflation means 150 is connected to a retaining means 180 such as a belt. In some embodiments the inventive therapeutic compression apparatus is a lower leg compression apparatus such as the Aero-Wrap® by Sun Scientific, Inc. and disclosed in U.S. Pat. Nos. 9,033,906 and 7,967,766 and 7,559,908 and U.S. Ser. No. 13/444,600 and U.S. Ser. No. 16/328,718 which are all incorporated herein. In some embodiments the inflation means may be a manual hand pump, foot pump, mechanical pump, electrical pump, battery-operated pump, static pump, intermittent pump, varying pump, automatic pump, pneumatic pump, negative pressure pump, suction pump or vacuum, pulsing pump, or any combination thereof or any other known or developed source of inflation so as to provide a certain pressure within the inventive therapeutic compression apparatus so to provide compression in use by the patient. In some embodiments the inflation means is connected to the inventive therapeutic compression apparatus by a hose or tube 160. In some embodiments of the inflation means is connected to a retaining means such as a belt or wrap to be worn by the user.

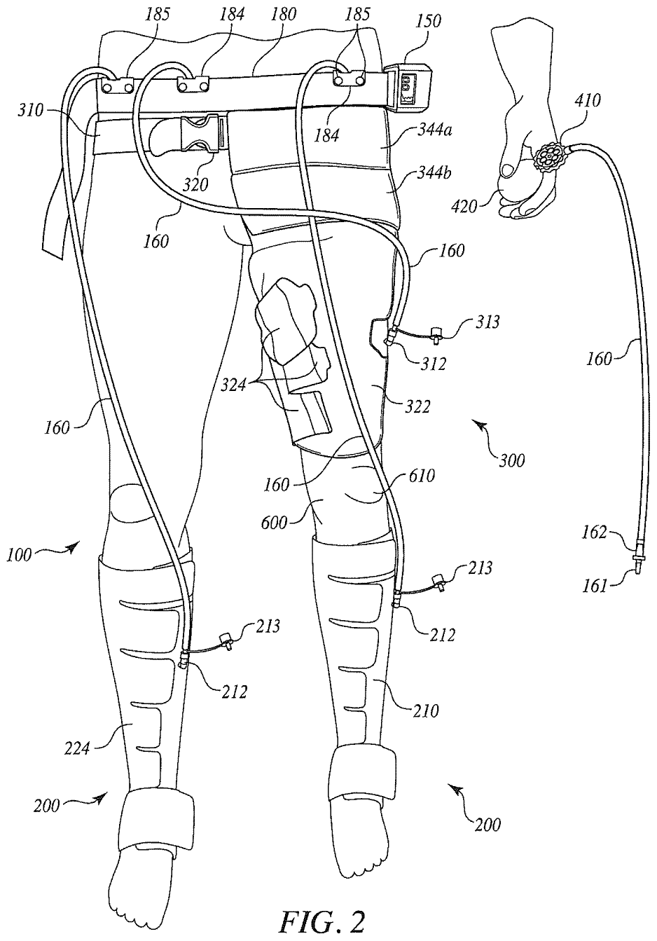

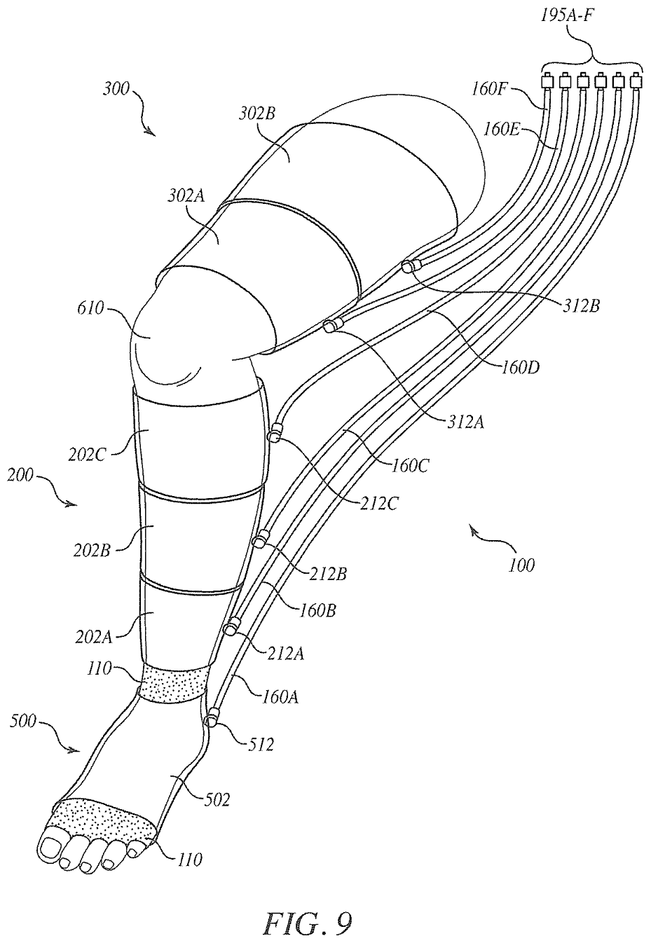

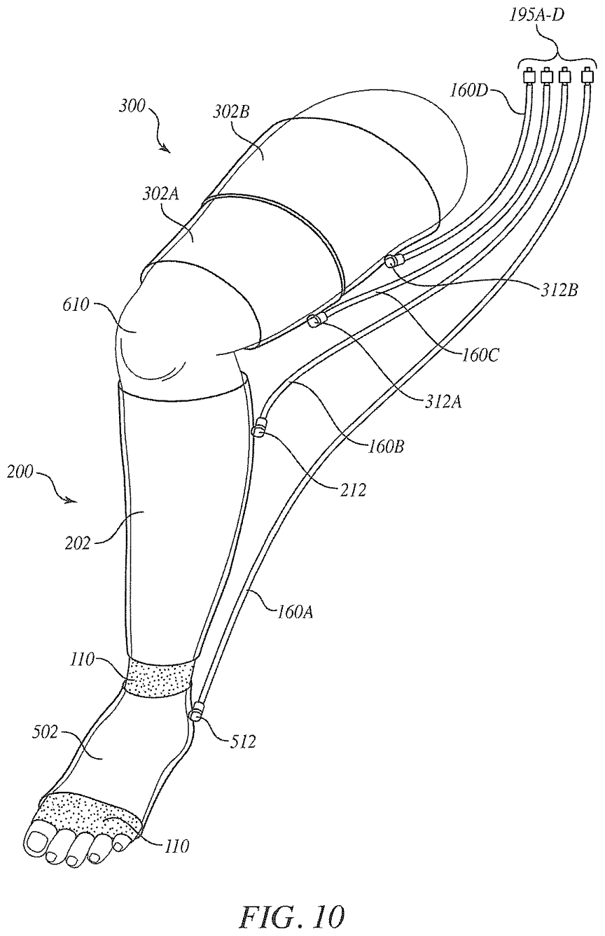

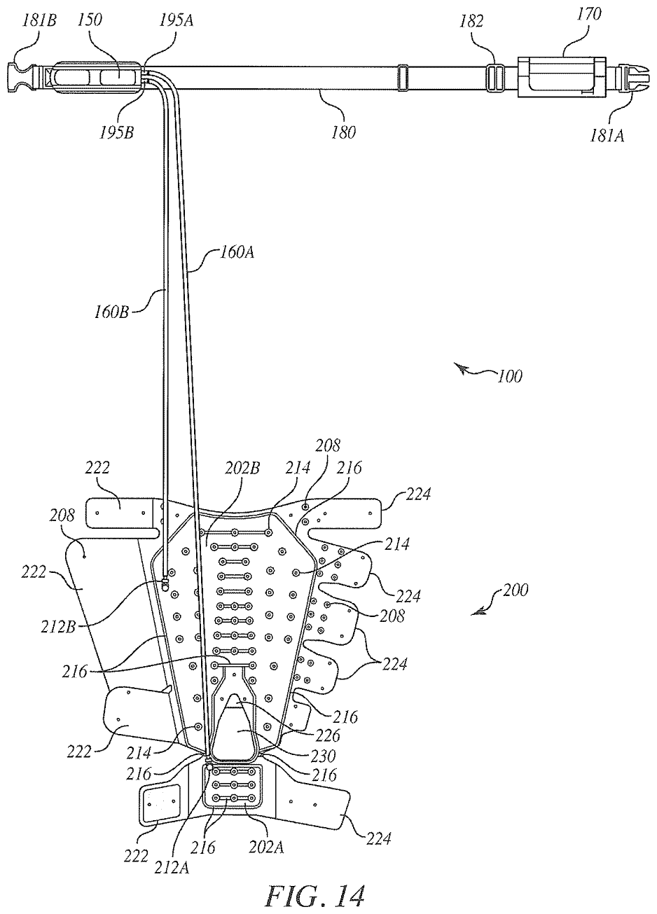

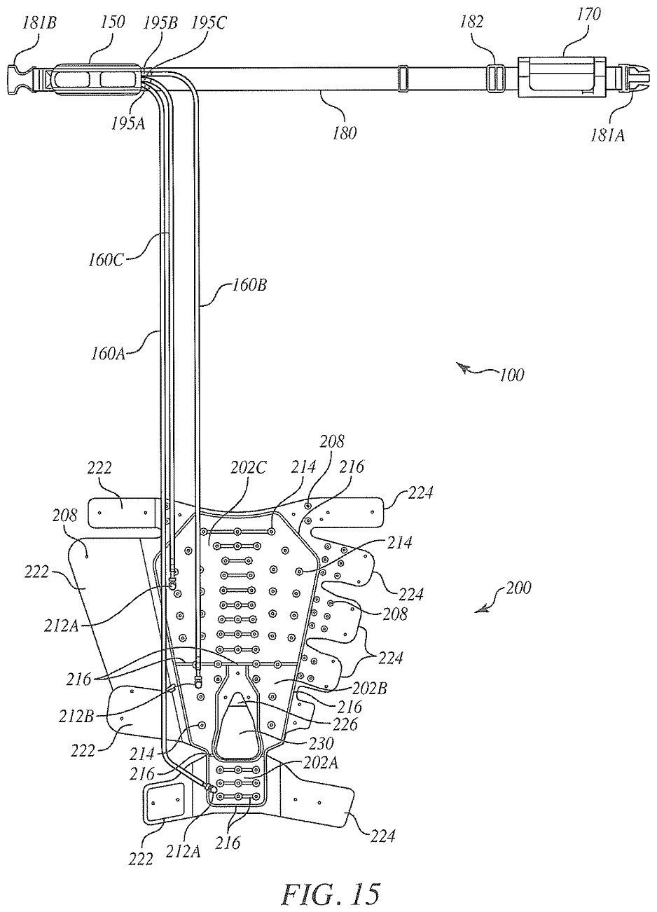

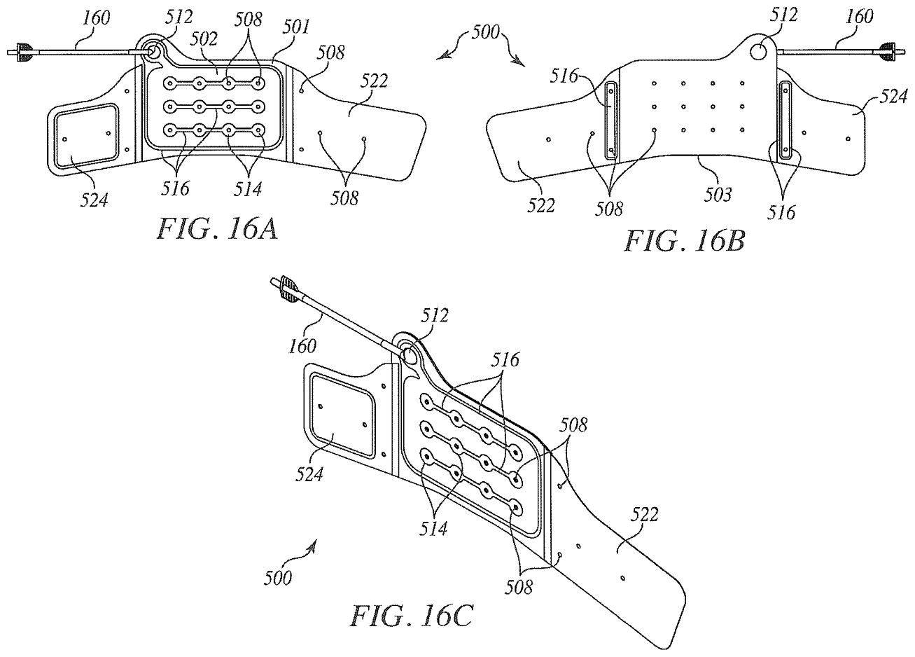

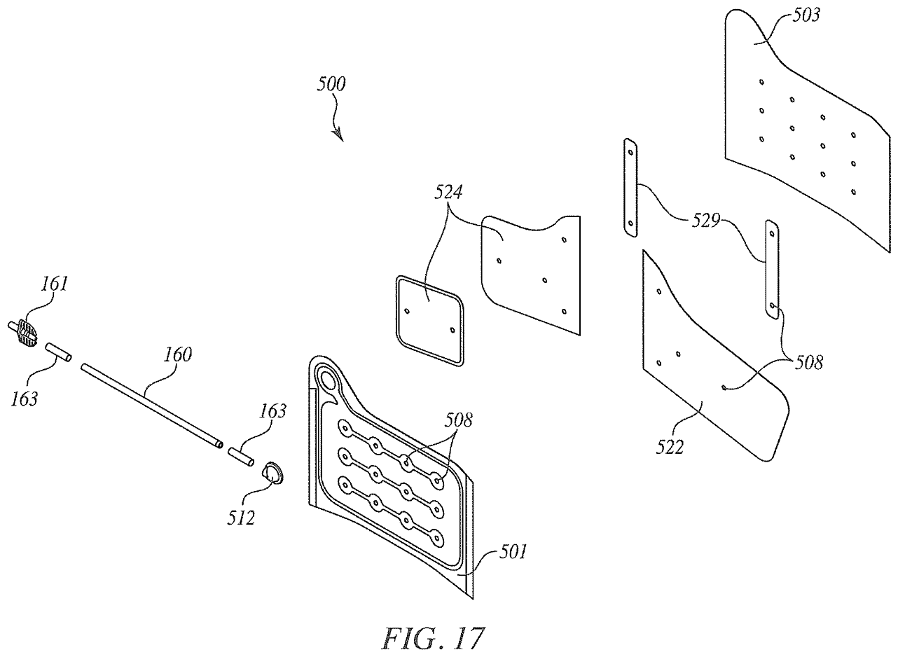

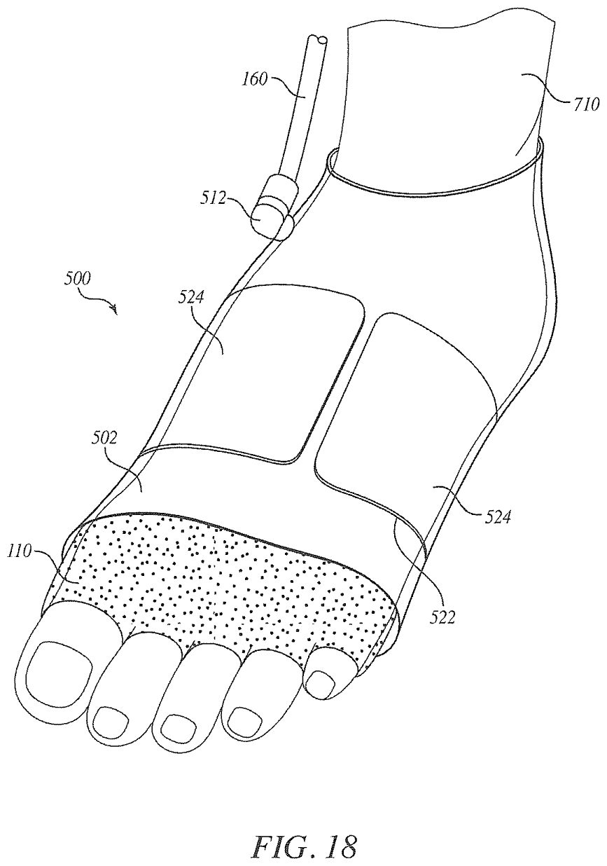

The inventive therapeutic compression apparatus 200, 300, 500 may be comprised of at least one bladder 202, 302, 502 and may be more than one bladder such as by way of example only 202A, 202B, 202C, 302A, 302B (not shown could include multiple bladders 202D, 202E, 302C, 302D, 502A, 502B, 502C and more) with the bladders being for example a compression bladder either integrally formed in the inventive therapeutic compression apparatus 200, 300, 500 or the inventive therapeutic compression apparatus 200, 300, 500 is configured for the bladder to be inserted (not shown) within the inventive therapeutic compression apparatus 200, 300, 500. The inventive therapeutic compression apparatus 200, 300, 500 is configured and adapted to wrap around a patient's limb such as in for instance a leg, calf, knee, foot, ankle, thigh, torso, arm, neck or any other limbs. The inventive therapeutic compression apparatus 200, 300, 500 is not limited to the limbs or body parts listed above but could be any body part such as without limitation a foot, ankle, calf, lower leg, knee, thigh, groin, hip, leg, buttocks, torso, stomach, chest, shoulder, arm, elbow, hand, wrist, neck, head or the like and any combinations thereof. As shown in FIG. 1 one embodiment of the inventive therapeutic compression apparatus is a lower leg therapeutic compression apparatus 200 and as shown in FIG. 2 also includes a thigh inventive therapeutic compression apparatus 300 along with a second lower leg therapeutic compression apparatus 200. The inventive therapeutic compression apparatus 200 as shown in FIGS. 1-2 and 8-10 is a wrap member 220 with a proximal end portion (top as oriented in FIGS. 1-2 and 8-10 closer to the knee of the user) and opposed distal end portion (bottom as oriented in FIGS. 1-2 and 8-10 wrapped around the foot of the user) which is configured and adapted to conform around a patient's lower leg including the foot and calf and provide compression through the inflation of bladder. In this embodiment the inventive lower leg therapeutic compression apparatus 200 includes an inner sheet 203 and outer sheet 201 which are made out of a nylon laminated polyurethane sheet which are configured and adapted to be RF welded together to form the wrap 220. However, any other suitable materials which are weldable or otherwise joined while being airtight to form a bladder can be used such as films, polymers and the like, and in some embodiments (not shown) there is only one sheet and no bladder with the sheet having a SSI of at least greater than 10. As shown in FIGS. 1-2, 8-11 and 13-21 continuous peripheral weld lines 216, 316, 516 form an airtight boundary of integrally formed bladder 202, 302, 502. In the exemplary embodiments of FIGS. 1-2 and 8-10 bladder 202 is a single continuous bladder throughout from the lower leg portion to the foot portion of the inventive therapeutic compression apparatus 200, however, it is envisioned that the inventive therapeutic compression apparatus 200 could have multiple independent bladders (202A, 202B, 202C, etc.) either separately inflatable or inflatable through a one-way valve or other desired inflation/deflation configuration as shown in certain non-limiting embodiments of FIGS. 9, 11, 14-15 and 20-21.

In this embodiment, hook and loop fasteners 224 are provided along the edge of inner and outer sheets in order to ease adjustment and secure lower leg inventive therapeutic compression apparatus 200 on a patient's limb such as for example a calf or foot. It is envisioned that the thigh inventive therapeutic compression apparatus 300 can includes hook and loop fasteners 322, 324 but also could be secured to a patient's thigh by other means, such as zippered, buttoned, or be cuff shaped by other such suitable means. Further, it is also envisioned that hook and loop closures 224, 324, 524 can be replaced by material similar to that of an ankle strap, knee strap, hip strap or any other type of strap (including those described below) and be welded/sewn/attached to bladder for improved comfort. In another embodiment the foot inventive therapeutic compression apparatus 500 includes hook and loop fasteners 522, 524 but also could be secured to a patient's foot by other means, such as zippered, buttoned, or be cuff shaped by other such suitable means.

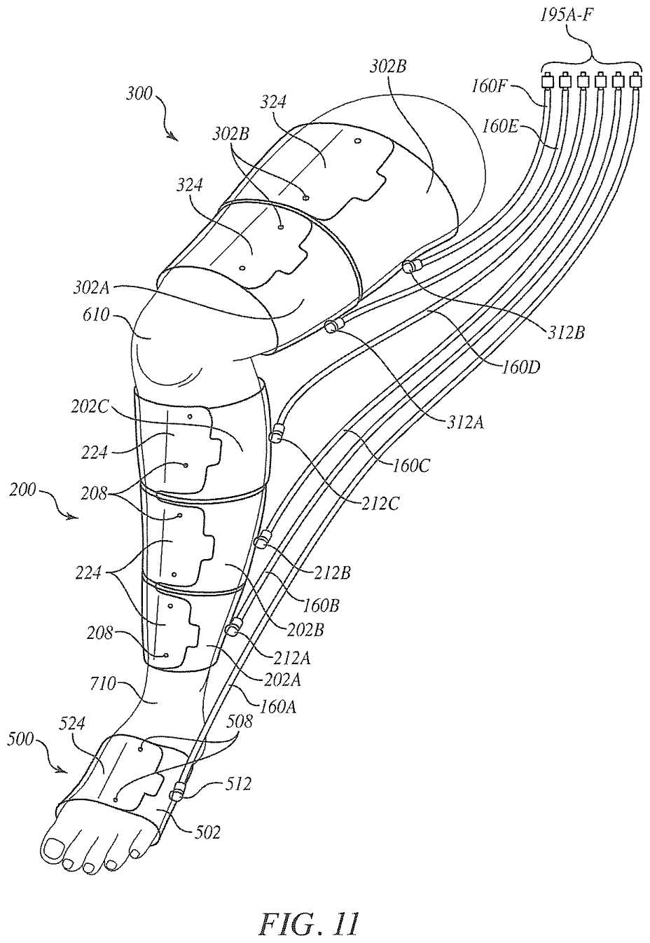

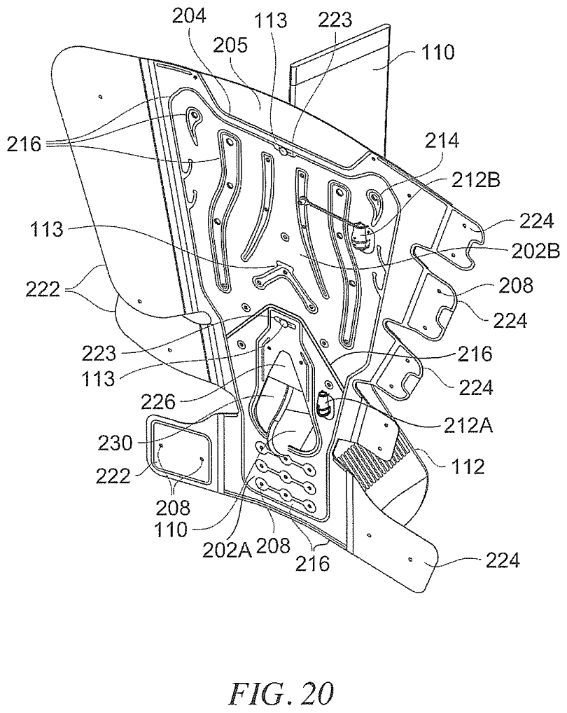

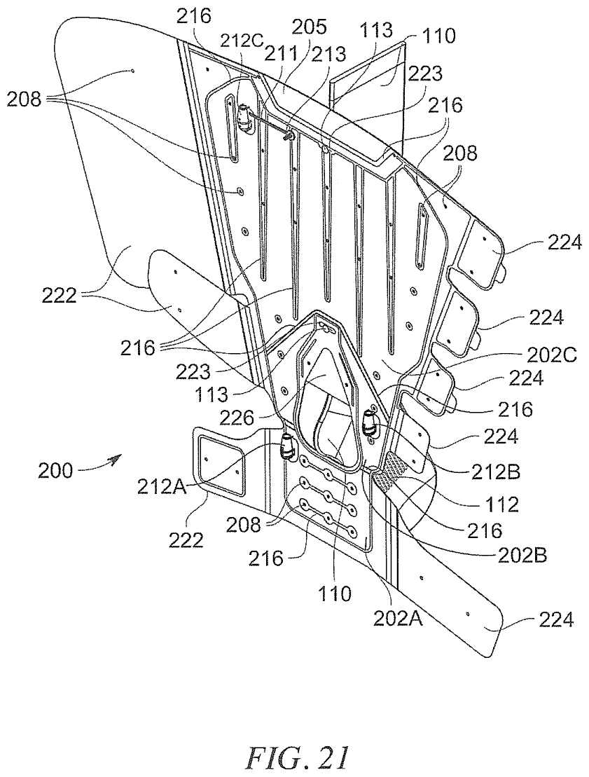

Referring now to FIGS. 1-2, in this embodiment the inventive therapeutic compression apparatus 200 has a bladder integral within inner sheet 203 and outer sheet 201, with the location and desired preconfigured compression gradient profile obtained cost-effectively. A number of different embodiments of bladder configurations can be used in the inventive lower leg therapeutic compression apparatus 200 such as those configurations described above as well as the embodiments shown in FIGS. 11, 14-15 and 20-21 have different gradient compression profiles and/or gradient pressure profiles based on the position and selection of the spot welds 215 and weld lines 216, which is also applicable to the inventive foot therapeutic compression apparatus 500 including chosen and positioned spot welds 514 and weld lines 516, and applicable to the inventive thigh therapeutic compression apparatus 300 including chosen and positioned spot welds 314 and weld lines 316. FIGS. 1-2 show inventive therapeutic compression apparatus 200 having bladder with a plurality of spot welds 214 therein. Spot welds 214 are strategically placed within bladder 202 in any of the embodiments such as FIGS. 11, 14-15 and 20-21 (and those not shown) in a predetermined pattern based on the desired gradient profile relative to the compression needed at the patient's treatment site. Spot welds 214 and/or weld lines 216 enable bladder 202 to define the gradient compression profile and/or gradient pressure profile when inflated through inflation port 212. The geometric placement of spot welds 214 and/or weld lines 216 within bladder 202 allows increased inflation of certain portions of bladder 202, and can create one or more fluid chambers within bladder 202. This configuration is particularly useful when compression is needed to improve fluid movement (e.g., blood, lymph, etc.) within the body. Further, linear weld lines 216 allow for better compression along the calf of a patient's leg by increasing tension applied as well as the sole of the foot area of a patient. This increased tension can generate a more effective compression in order to increase venous flow. Linear weld lines 216 located laterally along calf create a ribbed portion, which keeps the inflated profile of inventive therapeutic compression apparatus 200 compact which can further increase ambulation and reduce interference with a patient's clothes. Linear weld lines 216 located vertically as shown in FIG. 21 along calf create a vertically ribbed portion and a different gradient compression profile than as shown in FIGS. 1-2, 11 and 14-15 compared to the geometric placement and design of the curved weld lines 216 in FIG. 20 which creates yet another different gradient compression profile on the calf of the user. Other geometric configurations and placement or location of both the spot welds 214 and weld lines 216 can be imagined to create an endless different amount of gradient compression profiles and/or gradient pressure profiles.

It can be appreciated that depending on the location of the inventive therapeutic compression apparatus 200, different pressure gradients and/or compression gradients and their profiles may be utilized. Other possible gradient pressure profiles may be imagined based upon the geometric location of the spot welds 214, alone or in connection with the linear welds 216. The spot welds 214, 314, 514 shown in FIGS. 1-2, 14-17, 19 and 21 are in the shape of circles where the spot welds 214 in FIG. 20 are a different geometric shape such as a tear shape, though any geometric shape and any placement location on the inventive lower leg, thigh or foot and Further, weld lines 216 may be used to separate bladders within each of the inventive therapeutic compression apparatus 200, 300, 500 to create and separate bladders 202A and 202B, or 202A and 202B and 202C, or 302A and 302B, or 502A and 502B and the like, within each inventive therapeutic compression apparatus 200, 300, 500. For example, in the thigh inventive therapeutic compression apparatus 300, depending on the location of the limb to be compressed, such as the medial area of the thigh, the linear welds 316 and spot welds 314 may be in different geometric configurations than those shown in FIGS. 1-2. Again the gradient pressure profile and/or the gradient compression profile may be based on the geometric pattern of the spot welds 314 alone or in combination with linear welds 316. In another embodiment of the inventive therapeutic compression apparatus, not shown, the gradient compression profile and/or gradient pressure profile may be based on the pressure level from the inflation means alone, or combined with the overall shape of the bladder 202, 302.

It can be appreciated that depending on the location of the inventive therapeutic compression apparatus being placed on the patient's body part or limb, different pressure gradients may be utilized such as on the wrist, arm, shoulder, torso, neck and other anatomical body parts. Further, different pressure gradients and/or compression gradient profiles may be employed depending on the treatment (general swelling, lactic acid build up, arterial ulcers, venous ulcers, lymphedema, post-sclerotherapy, CVT, DVT, etc.) and the treatment site. Other examples of bladder pressure gradient profiles are described in U.S. patent application Ser. No. 12/911,563 and U.S. patent application Ser. No. 12/855,185, the disclosures of which are incorporated by reference in their entirety.

The bladder 202, 302, 502 configuration and shape may not include many spot welds 214, 314, 514 or weld lines 216, 316, 516 such as the non-limiting embodiments shown in FIGS. 9-10, 13, and 18 where the front portion of the inventive therapeutic compression apparatus 200, 300, 500 do not shown any such welds and instead any welds are on the bottom portion of the respective inventive therapeutic compression apparatus 200, 300, 500.

The bladder 202, 302, 502 when inflated within the inventive therapeutic compression apparatus 200, 300, 500 has a SSI of at least about 10 or greater. The inelastic inflated bladder has a SSI of at least about 10, preferably about 10-50. The SSI assists in the compression therapy for the user to prevent or treat CVT, CVI, DVT, lymphedema and other swelling issues on the user's limb as well as venous and arterial ulcers. Commonly known SSI for elastic bandages or garments are in the range of about 1 to about 5 or about 6, while certain known inelastic compression apparatus have a SSI in the range of about 5-10. At this time no inelastic compression apparatus including a bladder when such bladder is inflated, has a SSI of greater than about 10. A SSI of about 10 is generally acceptable for an inelastic compression apparatus with the inventive therapeutic compression apparatus having a SSI of at least about 10 and generally greater than 15. The higher the SSI then typically the better compression for the user with the bladder is inflated. The higher SSI translates generally to a level of compression comfortable relatively speaking with vascular push but constricting blood. The inventive therapeutic compression apparatus is able to combine compression to prevent or treat both arterial and venous disease. Whereas the arterial disease needs vessel and flow, the venous disease needs compression, which are found in the inventive therapeutic compression apparatus when the bladder is inflated and the apparatus is on the target limb of the user. For a user than has mixed disease of both arterial and venous disease it is better to have inelastic compress with the added benefit of high pressure without constantly constricting vessels. The inventive therapeutic compression apparatus 200, 300, 500 is able to achieve both high pressure and high stiffness which is then beneficial to prevent and treat venous disease, lymphedema, CVT, CVI and the like. The inventive therapeutic compression apparatus 200, 300, 500 has been measured with a SSI of up to about 40-50, preferably when inflated and in use of about 10 to about 30.

Compression therapy is a widely used standard of care in the treatment of a variety of swelling disorders, such as chronic venous insufficiency disease and lymphedema. Compression therapy relies on the external use of pressure to squeeze the underlying anatomy and helps to reduce swelling and improve circulation. Gradient compression is particularly effective with more pressure being applied more distally (further) from the heart with the pressure reducing proximally (closer). This helps to squeeze the body in a manner to help spur circulation and reduce the limb size. In general, there are two types of compression, static and intermittent. Static is most common and is constant compression meant for all day wear while intermittent is the cyclical application of compression through a pump and has benefits particularly for sporadic use when the user is sedentary.

For static all-day compression, there are a variety of compression products and techniques but in general static compression has two mechanisms of action. For example, a supporting effect may help to reduce the available limb volume to manage the amount of leg swelling. Further, a dynamic effect may include compression that causes or helps to improve circulation of blood and fluid, particularly when the user walks around. Compression squeezes the circulatory system into better contact with the muscles (for example, calf with lower-leg compression) to improve the body's efficacy of fluid movement. Those with chronic venous disease may not get fully effective circulation without compression. Compression therapy is widely regarded as effective treatment for lower leg swelling diseases when used properly. By squeezing the outside of the legs, compression helps to bring down swelling and to improve circulation of the trapped fluids. To be effective, compression must be used consistently and often-especially static compression when on your feet and walking around.

Two of the ways that static compression is helpful are: 1. supportive compression (compression that helps keep the leg from further swelling) and 2. dynamic compression (compression that helps improve your body's natural circulation, especially when moving as it keeps the circulatory systems engaged with the musculoskeletal system. There are different types of known compression products that are useful in different situations where some are pulled up like a sock and some are rolled on as a bandage. Each of these types of products can be categorized on a scale of Elastic to Inelastic in terms of how stretchy the materials are.

As stated above, compression therapy has been used effectively for treating patients with chronic venous insufficiency. It works by improving venous hemodynamics and reducing edema because of the underlying stiffness and elasticity of the compression device. There are several types of known conventional compression options such as medical grade elastic compression stockings, inelastic compression stockings and inelastic compression wraps. Each of these have advantages and disadvantages. Inelastic compression compared to elastic provides higher stiffness and therefore better control of venous hemodynamic impairment in patients with more severe venous disease. Compression wraps offer easier application for patients when compared to compression stockings. The inventive therapeutic compression apparatus solves these problems by prevent or treating arterial and venous issues in that the inventive therapeutic compression apparatus 200, 300, 500 has a SSI of at least about 10 or greater when inflated and wrapped on the user's target limb. Stiffness is the rigidity of an object, i.e. the extent to which it resists deformation in response to an applied force. The stiffness of a compression device can be calculated by measuring the interface pressure between the device and the skin. The SSI is defined as the difference between the standing and the supine pressure measured at the B₁ point. B₁ point is the transition point between the gastrocnemius tendon and muscle about 10-15 cm above the inner malleolus. Elastic compression devices typically have SSI <10, sometimes less than 5, compared to inelastic devices showing an SSI >10. The inventive therapeutic compression apparatus 200, 300, 500 has a SSI of at least about 10 or greater, preferably from about 15 to about 40 Notably in certain embodiments such as shown in FIGS. 20-21 the inventive therapeutic compression apparatus 200, 300 also has an elastic portion 205, 318 configured to conform to the shape of the target limb and anatomy and keep the inflated inventive therapeutic compression apparatus 200, 300 on the target limb without slipping down the limb (such as the calf and thigh in these non-limiting examples) when the user is moving or walking. Thus there is a combination of SSI of at least 10 with a certain elastic portion on the inventive therapeutic compression apparatus 200, 300, 500 with other embodiments not shown.

Elastic materials compress all the time, meaning that they can feel “tight” and pinch even when at rest. But when you walk around, they stretch, meaning that they can give up some of their compression, reducing the dynamic compression effect. With lower leg venous and lymphatic blood return, the calf muscle plays a very important role in helping squeeze fluid against gravity up into the body and back into circulation. In fact, the calf is known as the second heart. Elastic compression of the leg, by the material properties, ends up stretching when the leg is engaged (both calf and thigh as well as knee and ankle), losing some of the inward pressure of the compression and losing fluid return effectiveness. Inelastic materials by comparison, are known to feel more comfortable at rest, and have much less stretch when walking around, thereby allowing them to have comfortable supportive compression and more effective dynamic compression. Compression stockings, for example, are elastic and are pulled up in place. They are manufactured as a circular knit with a predefined stretch built in with yarn selection. They are known to be difficult to apply at higher medically required compression levels. In contrast compression bandages come wound up in a roll, and are applied, often by a skilled caregiver, around the leg with overlap to apply compression. Compression bandages can be made with different levels of elasticity, and often are applied with multiple layers with different levels of elasticity in an attempt to realize a certain compression level or SSI amount.

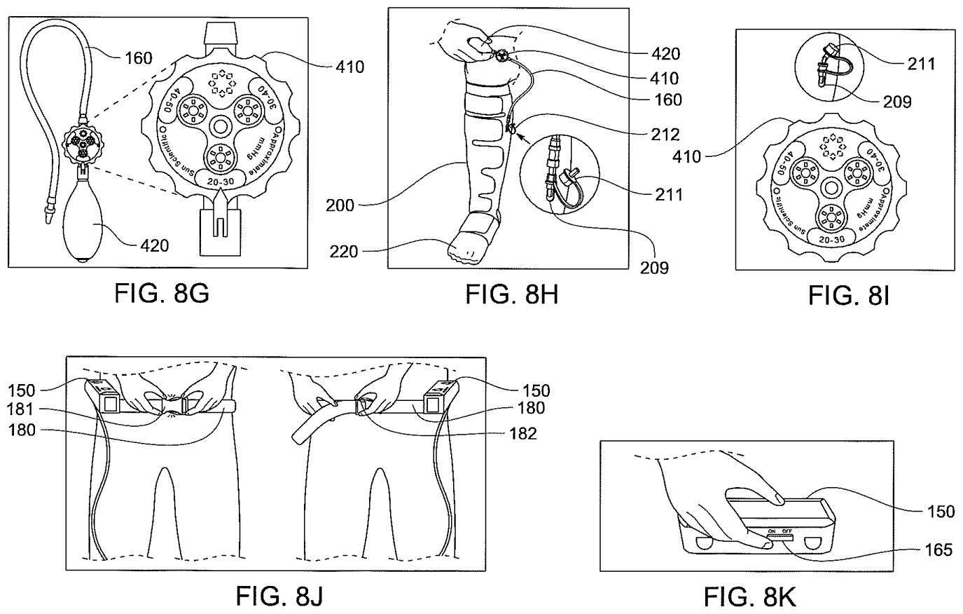

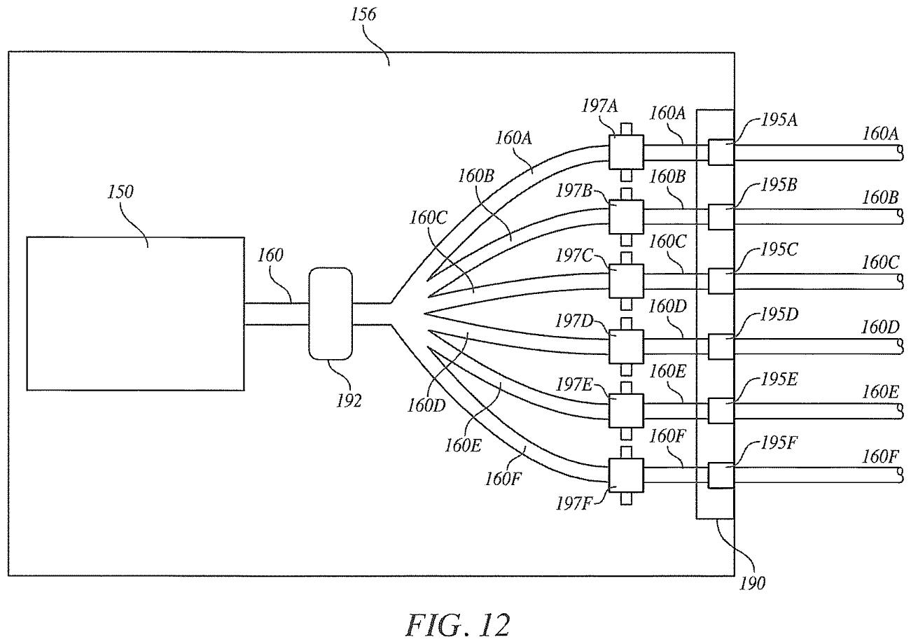

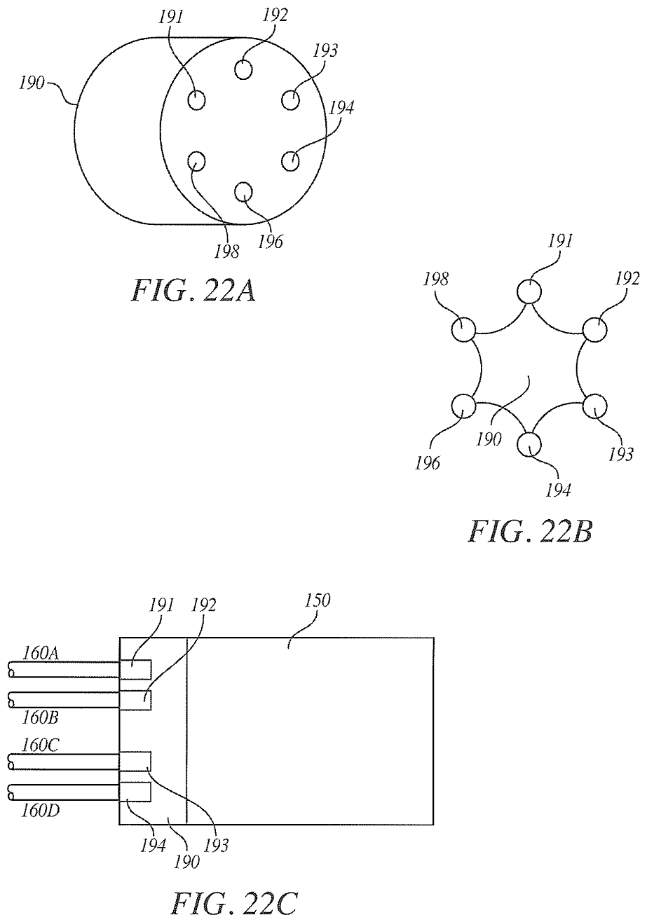

The inventive therapeutic compression apparatus 200, 300, 500 includes a SSI of at least about 10 or greater when the wrap 220 is placed on the user's target limb and the bladder 202, 302, 502 is inflated. As shown in FIGS. 1-4B, 12, 14-15 and 22C, one of the inflation means is a device 150 which is a pneumatic pump capable of attaching to inflation ports 212 (212A, 212B, 212C), 312 (312A, 312B), 512 to inflate bladder 202 (202A, 202B, 202C), 302 (302A, 302B), 502 within the inventive therapeutic compression apparatus 200, 300, 500. It can be appreciated that other mechanical or automatic inflation pump (not shown) can also be attached to inflation port ports 212 (212A, 212B, 212C), 312 (312A, 312B), 512 to inflate and deflate bladder (202A, 202B, 202C), 302 (302A, 302B), 502 within the inventive therapeutic compression apparatus 200, 300, 500 to provide pulsating pressure to a user's limb. For example, as shown in FIGS. 2 and 8G-8H, the inflations means 150 is a pneumatic pump and a second inflation means 150 is a hand manual pump 400 including a bulb 420 for manually pumping of air fluid and a hand dial 410 including a check valve within. A number or variety of inflation means can be employed such as a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient. A valve 290 is incorporated into inventive therapeutic compression apparatus 200 in the inflation port 212 to allow a user to selectively deflate bladder 202 of the inventive therapeutic compression apparatus 200. Further, a check valve (not shown) or relief valve (not shown) is incorporated with either inflation means 150 or bladder 202 to prevent over-inflation once a maximum pressure is detected. Examples of relief valves are described in U.S. Pat. Nos. 7,276,037 and 7,850,629, the disclosures of which are incorporated by reference in their entirety. The inflation means 150 may include a manifold 190 as shown by non-limiting examples in FIGS. 12 and 22A-22C that controls inflation, maintenance and deflation of each bladder 202 (202A, 202B, 202C), 302 (302A, 302B), 502 connected via a hose 160 (160A, 160B, 160C, 160D, 160E, 160F) to the applicable inflation port 212 (212A, 212, 212C), 312 (312A, 312B), 512. In this embodiment each inventive therapeutic compression apparatus 200, 300, 500 may have more than one bladder such as 202A, 202B, 202C and 302A, 302B such that a separate hose 160A, 160B, 160C, 160D and 160E connect to the applicable inflation port 212A, 212B, 212C and 312A, 312B as shown in FIGS. 9-11, 13-15 and 20-21. Other configurations are possible depending on the number of separate bladders within each inventive therapeutic compression apparatus 200, 300, 500.

Referring now to FIGS. 1-2, 8J-8K, and 14-15, once the inventive therapeutic compression apparatus 200, 300 is secured around a patient's lower leg, bladder 202, (202A, 202B, 202C), 302 (302A, 302B) is inflated and not able to shift out of place, thus increasing comfort and reducing fitting issues on the patient. In order to increase the ease of ambulation by a patient and practicality and mobility of the patient, in this exemplary embodiment, the inflation means 150 is connected to a retaining means 180, for example a belt. Any retaining means 180 may be employed such as for instance, and not shown, a thigh, hip or waist strap can be used. If a strap is used, the strap may be pulled tight against a patient's leg and hip so as to reduce slippage of the inventive therapeutic compression apparatus 200, 300 and the inflation means 150.

In this embodiment, the retaining means 180 is a belt or strap and includes a belt snap 181A (male connector) and a belt clip 181B (female connector), which are joined together by the belt strap 181B being inserted within the belt clip 181A and then snapped together. Other embodiments not shown may include a garter belt system or a belt buckle or any other known closing or connecting means. Again, the retaining means 180 if a belt may be closed or connected though other connecting means such as for example and not limited to hook and loop closure or VELCRO™ or any other known connecting means such as buckles, straps, buttons, snaps, zippers, hooks and other combinations. As shown in FIGS. 1-4 and 14-15, the retaining means 180 belt is worn at the waist of the patient. In another exemplary embodiment, the retaining means 180 may be a hip strap (not shown) or a waist strap (not shown as what is shown is a belt embodiment) is configured and adapted to improve wearability of the inflation means 150 and increased ambulation for the patient.

Inelastic hook and loop (“Velcro”) wraps have been introduced that have a hook and loop outer material onto a neoprene-like material with a small amount of stretch with straps that are pulled over to apply a stiffer than elastic stocking compression. These products provide significant improvements to known issues of elastic stockings and rolled bandages, in that they are easier to wrap around the leg given their hook and loop attachments; however, there are significant drawbacks in that they require hand strength to pull the straps to the desired compression level. These products require some amount of stretch in their base material to apply compression to be applied, but that stretch also means that the inelasticity of the product is sub-optimal. It is also very difficult to quantify the compression being applied with this hand strength technique.

Fully inelastic materials are not used due to the inability to apply compression in the static state or to get a proper anatomical fit without having multiple pieces stitched together in a pattern that would adjust to the multiple contours of the body. The inventive therapeutic compression apparatus 200, 300, 500 is a compression garment that anatomically fits the leg and foot but is made primarily from inelastic materials. Current conventional inelastic compression apparatus look like a cone for the lower leg when lying flat not inflated in that the upper portion to be placed nearer the knee is wider compared to the less wide portion to be placed nearer the ankle as it mimics the wider portion of the calf on the lower leg compared to the ankle area for users. As shown in FIGS. 20-21, the inventive therapeutic compression apparatus 200 includes an elastic portion 205 located on the upper aperture 204 of the apparatus 200/wrap 220 to assist in the anatomical fit of the apparatus 200/wrap 220 when placed on the lower leg of the user versus the current known compression wraps are in the shape of the cone from bottom to top so they have to be either cut down by the user or when placed on the lower leg stick out further than it needs to be and does not hug the calf which is a problem. The inventive therapeutic compression apparatus 200 solves this problem by including the elastic portion 205 to assist in the fit of the apparatus 200/wrap 220 on the lower leg when placed on the user. Further, by using air-tight inelastic materials, and an inflation means, the garment can be applied around the leg and then inflated with a compressed fluid (often air), with the result of compression with better inelastic properties (a higher static stiffness index of above about 10, preferably above 15 or in the range of about 10 to about 50). The air or any suitable compressed fluid is also able to be measured by measuring the actual amount applied or by feedback pressure, allowing ways to measure, control, and adjust the compression being applied such as by way of non-limiting example shown in FIG. 12 via switches or valves 197 (197A, 197B, 197V, 197D, 197E, 197F, etc.) or via other sensors not shown. The inventive therapeutic compression apparatus 200, 300, 500 can be designed in a way to apply more compression distally than proximally through multiple inflation channels, or design of the shape of the bladders 202, 302, 502, or the location and placement and pattern of the spot welds 214, 314, and weld lines 216, 316, 516.

In order to have a proper anatomical fit on the lower leg for example, the inventive lower leg therapeutic compression apparatus 2000 may have an elastic insert 205 that are placed during the manufacturing process in a pre-stretched configuration, providing a desired 3D shape to an inelastic garment. This process of laying materials down on pins (not shown) with varying elastic properties at different stretch amounts means that a 3D shaped garment can be manufactured in the flat state, providing significant cost and efficiency improvements to other manufacturing means. For example the steps may include: (1) an inelastic outer sheet 201 is laid down on a flat surface with pins; (2) the elastic insert 205 is pre-stretched and held in the stretched state on the same pins; (3) the inelastic inner sheet is laid down on the same pins within the aperture 204, sandwiching the pre-stretched elastic insert 205 between this inner 201 and outer sheet 203; (4) the three layers are fused together in the flat state (radio frequency welding, ultrasonic welding, sewing, or any other means to connect) and (5) the inventive lower leg therapeutic compression apparatus 200 is removed from the pins, allowing the pre-stretched elastic portion 205 material to be free and to contract, curling the inventive lower leg therapeutic compression apparatus 200 into the desired 3D shape. In this embodiment, the inner 201 and outer 203 sheets are inelastic and may consist of multi-layer laminates, capable of being air-tight and inflatable. In other embodiments, the inelastic materials could have additional elastic inserts or mesh portions 217 inserted in a way that provides a 3D anatomical shape and also the predetermined compression profile, by stretching more or less depending on where the compression profile is desired. The additional elastic or mesh portions 217 may assist in anatomical positioning as well as heat release for the user's limb due to the inelastic portions of the inventive lower leg therapeutic compression apparatus 200. Similarly, the inventive thigh therapeutic compression apparatus 300 includes an elastic portion 318 to conform to the anatomy of the groin area and prevent slippage of the inventive thigh therapeutic compression apparatus 300 down the leg and thigh of the user when he or she is moving and notably walking and in turn assists and has better efficacy in reducing, treating and even preventing tissue swelling, lymphedema, ulcers (arterial and venous), CVI and DVT as well as increasing circulation on the thigh and overall leg of the individual user.

It will be appreciated that the chambers of the bladder 202 (202A, 202B, 202C), 302 (302A, 302B), 502 may be filled by air, fluid or other known means of inflation. It will also be appreciated that the bladder 202 (202A, 202B, 202C), 302 (302A, 302B), 502 can be arranged to receive air and be inflated using a manual pumping bulb (as shown in FIG. 2), or can be inflated by an electric air pump 150 which can use batteries or AC wall current to pump air into the chamber(s). The inventive therapeutic compression as shown in FIGS. 9-11, 14-15 and 20-21 give examples of inventive therapeutic compression apparatus 200, 300 including two separate bladders 202A, 202B or 302A, 302B or three separate bladders 202A, 202B, 202C. Each of these separate bladders may be sequentially inflated, then released, then inflated and repeated depending on the target limb and the target pressure for each part of the target limb. The inflation port 212 (212A, 212B, 212C) of the inventive therapeutic compression apparatus 200 is universal in that it can connect to a multiple of different types of inflation means. Any known source of air or fluid may be employed whether manual, mechanical, electrical, battery-operated or any other power sourced pump or pressure creator. The inflation means 150 may be a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient.

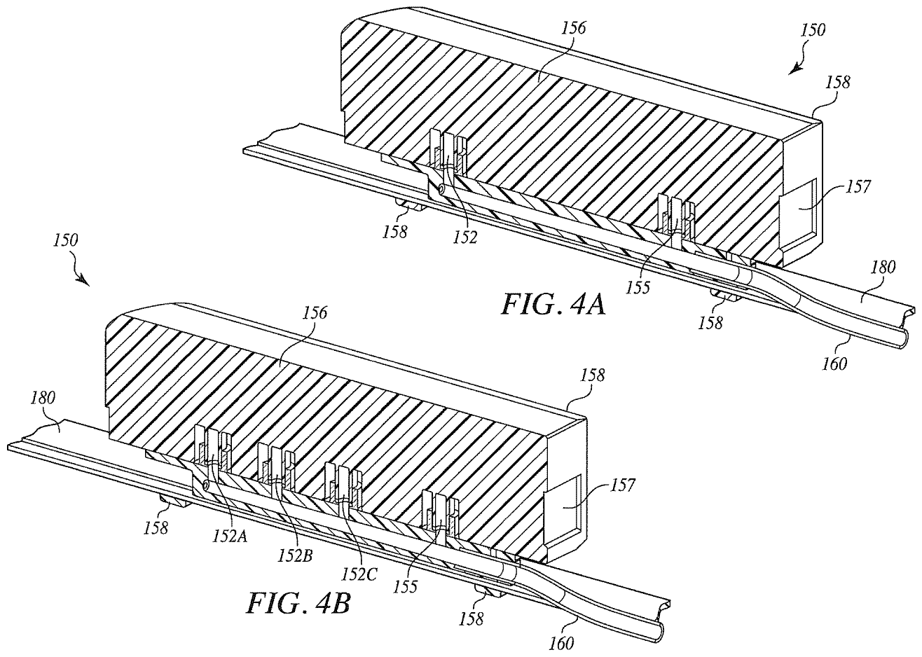

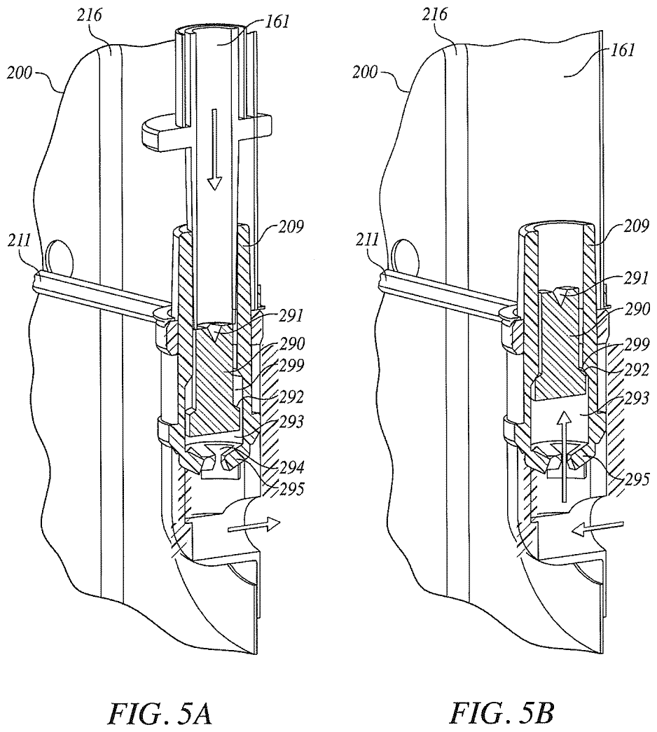

As shown in FIGS. 1-4, 9-11 and 14-15, the inflation means 150 is connected to the inventive therapeutic compression apparatus 200 via a connecting means such as a tube 160 or hose and as shown in FIGS. 9 and 12-13 there are multiple hoses 160A-160F going through a manifold 190 and connected to the applicable inflation port 212A, 212B, 212C, 312A, 312B, 502. Any other known connecting means may be employed beyond the non-limiting examples of tubes and hoses. The connecting means tubes or hoses 160 (160A, 160B, 160C, 160D, 160E, 160F) has two ends with one inserted into the respective inflation port 212 (212A, 212B, 212C), 312 (312A, 312B), 512 and on the other end has a tip or insertion part 195 (195A. 195B. 195C, 195C, 195D, 195E, 195F) that is inserted into apertures 197 (197A, 197B, 197C, 197D, 197E, 197F) in the manifold 190. The manifold splits the air from the air pump 150 into each of the respective tube 160 or hose and there is a sensor, valve, switch or some gateway in selecting the pressure level for each separate tube 160 or hose as well as whether to inflate, hold or deflate the respective bladder 202 (202A, 202B, 202C), 302 (302A, 302B), 502. The embodiments shown include a clear tube 160 (160A, 160B, 160C, 160D, 160E, 160F) connected to the inflation means 150 or hand held manual pump 400 and another embodiment of the tube 160 is shown with a covering 162 on the tube, shown as black cloth 162 so as to allow the user to wear the covered tubes 160 more easier under clothing or less likely to be seen when worn over clothing. The tube 160 (160A, 160B, 160C, 160D, 160E, 160F) is connected to the inventive therapeutic compression apparatus by inserting, for instance a male luer slip 161, into the inflation port 212 (212A, 212B, 212C), 312 (312A, 312B), 512. At the opposite end of the tube 160, the tube 160 is inserted into the inflation means 150 via the pump output port(s) 152 as shown in FIGS. 4A-4B but also via the manifold 190 by inserting the connectors 195 (195A, 195B, 195C, 195D, 195E, 195F) into each corresponding aperture 197 (197A, 197B, 197C, 197D, 197E, 197F) as shown in FIGS. 12 and 22A-22C, though other configurations are possible (not shown).

The inflation means 150 shown in the embodiment in FIGS. 1-4 is a pneumatic pump which is rechargeable via an electric charger, though the pump could also be battery operated or any other known power source. The inflation means 150 in this embodiment includes a base 151 connected to the retaining means 180 belt. The base 151 is connected to the main pump assembly via a series of screws 154 and O-rings 153. The main pump assembly is shown as 156 though the inner mechanical and electrical portion is not shown. The inflation means 150 of this embodiment is an electric powered air pump with interface pressure of 50 mm-Hg (for example to prevent DVT or treat CVI). The pump 156 may apply pressure constantly in a static status or may apply pressure intermittently, for example by applying 50 mm-Hg, holding for 10 seconds, then releasing until next cycle of 30-45 seconds, and repeating for a period of time. Other embodiments could include pressure levels of 60 mm-Hg, 75 mm-Hg, 80 mm-Hg, 90 mm-Hg, 100 nun-Hg or other known pressure levels, depending on the treatment plan and the target limb of the patient. There could also be multiple pressure levels within the pump so there is varying pressure during treatment. In the embodiment shown in FIGS. 9-21, the pressure levels may be noted through the manifold 190 and various sensors (197A, 197B, 197C, 197D, 197E, 197F) corresponding with each bladder 202A, 202B, 202C, 302A, 302B, 502 such that the bladders are inflated and deflated or maintained sequentially and the amount of pressure can vary vis-à-vis each separate bladder. Each inventive therapeutic compression apparatus 200, 300, 500 has one or more bladders 202, 302, 502 connected to an inflation means 150 with a controller such as the sensors, switches or valves 197 (197A, 197B, 197C, 197D, 197E, 197F) within the inflation means 150 and manifold 190 capable of sequential intermittent pneumatic compression, or any other type of compression, while also capable of being detached from the inflation means 150 while still holding or maintaining static compression. As shown in FIGS. 12 and 22A-22C, the controller or manifold 190 may utilize a sensor, valve, switch, check valve or ither mechanism to inflate, hold or maintain pressure or deflate the applicable bladder 202, (202A, 202B, 202C), 302 (302A, 302B), 502 at the then current pressure level such as 20 mm-Hg, 30 mm-Hg, 40 mm-Hg, 50 mm-HG, 60 mm-Hg or higher. Each of the sensors 197 (197A, 197B, 197C, 197D, 197E, 197F) are capable of opening, closing, or venting the air flow from the inflation means 150 to the applicable bladder via the applicable tube or hose 160A-160F such that the predetermined inflation sequence, which is sequential, produces different or the same pressures within different bladders 202, (202A, 202B, 202C), 302 (302A, 302B), 502 though other combinations may be employed as well as other sources of pressure beyond air flow. When inflated the inventive therapeutic compression apparatus 200, 300, 500 has a SSI of at least about 10 or greater.

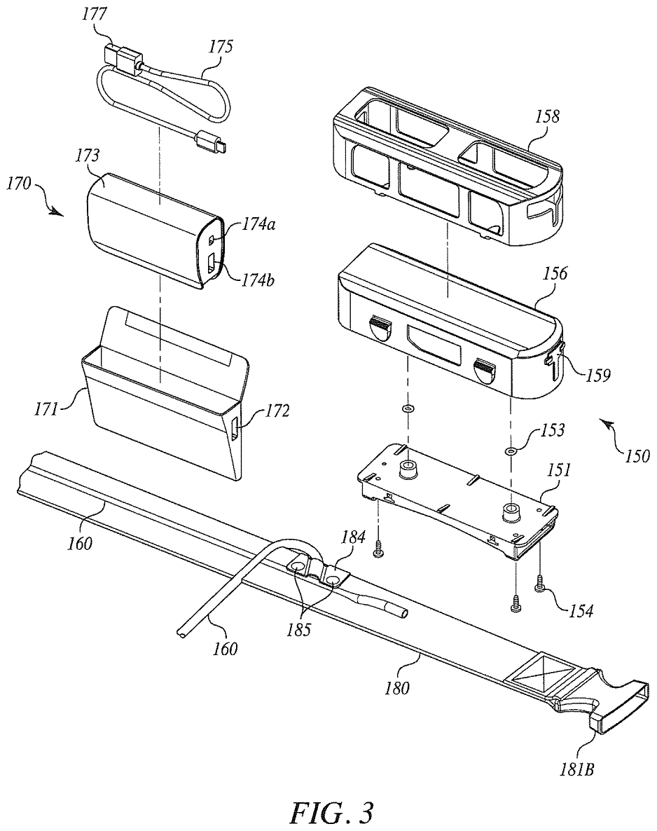

As shown in FIG. 3-4, the inflation means 150 main pump 156 includes a display 157 which in this embodiment shows remaining battery power level, the limb being compressed (or the specific bladder being inflated as in the embodiments shown in FIGS. 9-21), and elapsed time of this instant session in hours and tenth of hour. The display 157 can be modified to show varying pressure levels, other limbs being compressed, time left for activation in a set time period, or the like. The USB port 159 and cover 158 are on the opposite side in this embodiment of main pump 156, for recharging of the pump battery (internal mechanisms not shown). An ON-OFF switch 165 is included in this embodiment though the ON-OFF switch in other embodiments may be digital and includes various selections such as pressure level, static or intermittent status, time to operate at each pressure level and/or status, limb to be compressed if the pump 156 is connected to multiple inventive therapeutic compression apparatus 200, or the like.

An optional protective cover, shown in FIGS. 1-4, is a flexible cover 158 so to protect the inflation means 150 when dropped by the user or just common wear and tear on the pump mechanism or even to prevent over heating or chaffing at the waist of the user. The flexible cover 158 may be comprised of a polymer, rubber or other flexible materials or the like.

Once the inventive therapeutic compression apparatus 200, 300, 500 is secured around a patient's limb such as for instance a leg, bladder 202 (202A, 202B, 202C) is not able to shift out of place, thus increasing comfort and reducing fitting issues on the patient, along with the elastic portion 205 as well as the additional mesh inserts 217 as shown in FIGS. 20-21. In order to increase the ease of ambulation by a patient, in an exemplary embodiment, the inflation means 150 is connected to the bladder 202 (202A, 202B, 202C) via the male luer slip 161, and the inflation means 150 via the connector 195 (195A, 195B, 195C, 195D, 195E, 195F) into the manifold 190, and the inflation means 150 is connected to a retaining means 180, which in this embodiment is a belt. The user can then activate the main pump 156 via the ON-OFF switch 165. The user then wears the inflation means 150 similar to a mobile phone on an individual's belt. In this embodiment, the retaining means 180 is a belt which is adjustable to the waist of the user via an adjusting means 182 such as for example only a triglide and/or end clip. The user thus has increased mobility compared to conventional therapeutic compression apparatus where the inflation means is integral to the apparatus.

The inflation means or mechanism for each of the various embodiments of the present invention may include a hand pump, electric pump, battery-operated pump, remote controlled pump, air pump, gas pump, or any other known inflation means. A number or variety of inflation means can be employed such as a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient. Further, the inflation means could include a means to monitor or regulate the inflation. The inflation means could include programming such that the bladder 202 (including multiple bladders such as the embodiments shown in FIGS. 9-21 so that sequential inflation or deflation occurs in bladders 202A, 202B, 202C, 302A, 302B, 502) is inflated and deflated to a set pressure at intervals or at set times throughout the day or night when the compression apparatus is in use worn on the patient. For instance, by way of example only, the inflation means could be set to 40 mm-Hg at 9 am and then set to deflate to 20 mm-Hg at 11 am and then set to inflate to 30 mm-Hg at 12 μm and so on throughout the day and night for each patient individually with either sequential inflation and deflation of each applicable bladder 202, 302, 502, 202A, 202B, 202C, 302A, 302B. In another embodiment of the present invention, if the inventive therapeutic compression apparatus has two separate bladders (bladders 202A and 202B or 202A, 202B, 202C, or 302A, 302B or other embodiments not shown such as 502A, 502B or 302C or 202D, etc.) then there may be two separate inflation ports 212A, 212B, 212C or 312A, 312B each connected to the same inflation means 150 via the manifold 190, and the pressure levels of the first bladder 202A and the second bladder 202B could be the same or have different pressure levels compared to bladders 302A and 302B and son on with either constant or sequential inflation and/or deflation. For instance, by way of example only, the inflation means could be set to 40 mm-Hg for the first bladder 202A and set to 20 mm-Hg for the second bladder 202B, or each could vary and the inflation means be set to sequentially inflate, deflate, inflate, or hold pressure and compression for a period of time throughout the day as described above. As shown in FIGS. 2 and 4B, multiple inventive therapeutic compression apparatus 200, 300 can be connected to one main pump 150, 156 so that the pressure levels of each bladder 202 (202A, 202B, 202C), 302 (302A, 302B), 502 within each of the separate inventive therapeutic compression apparatus 200, 300, 500 may be the same or different, by way of example only, a right calf inventive therapeutic compression apparatus 200 could be set to 40 mm-Hg for the bladder 202 within the right calf inventive therapeutic compression apparatus 200 and set to 20 mm-Hg for the bladder 202 within the left calf inventive therapeutic compression apparatus 100, or each could vary and the inflation means be set to sequentially inflate, deflate, inflate, or hold pressure and compression for a period of time, etc. throughout the day as described above. The main pump 156 could be connected to three or more separate bladders within one inventive therapeutic compression apparatus 200 or could be connected to three or more separate inventive therapeutic compression apparatuses 200, 300 as shown in FIGS. 2 and 4B, three separate inventive therapeutic compression apparatuses are shown, though in this embodiment only two hoses 160 are connected to the inflation means 150 and thus the left lower leg inventive therapeutic compression apparatus 100 would have to be inflated via a hand pump 400 or a second inflation means (not shown). When inflated the inventive therapeutic compression apparatus 200 has a SSI of at least about 10 or greater.

As an example, treatment options would include intermittent pneumatic compression (HPIPC) 60 minutes twice daily for 16 weeks. In this example, the inflation means would have a pressure level of 120 mm-HG and the bilateral pressures of 120 mm Hg in a cycle time to provide sequential compression for 4 seconds (+/−0.5 seconds) followed by a 16-second rest period (+/−3.0 seconds), resulting in a 20-second cycle or 3 cycles per minute. This treatment may help reduce vascular issues such as lymphedema, DVT, CVI and the like.

In another example, treatment options could include reducing DVT through applying pressure pre-operation, for instance for the knee surgery, TKR, KRA, hip surgery, THR, HRA, or the like, to the target limb for a period of days or weeks or months prior to the surgical date. Prior to surgery the patient would apply compression via the inventive therapeutic compression apparatus and inflation means of the inventive system to reduce swelling of the target limb. During the actual operation and immediately after surgery while still in the hospital setting, the patient would use the same or a different inventive therapeutic compression apparatus connected to an inflation means within the hospital such as an intermittent compression pump accessible through the wall of the patient room or wheeled into the room, which may be considered mechanical DVT prophylaxis. Once discharged from the hospital setting, the patient can retain the same inventive therapeutic compression apparatus and use it at home by applying pressure via the inflation means 150 of an electrical pump configured to apply both constant static pressure and intermittent varying pressure based on the treatment plan. The method of use may reduce or prevent DVT, CVI and other vascular issues. The inventive therapeutic compression apparatus has a universal inflation port configured so it can connect to a hand pump (400) and electric pump (156) and a hospital pump (not shown) and many other pumps. This method of use of the inventive system may reduce swelling pre-surgery and post-surgery and also reduce or prevent circulation problems as well as reduce, treat or even prevent tissue swelling, arterial ulcers, venous ulcers, lymphedema, VU, DVT and other post-surgical complications. As stated above, the patient is more mobile and ambulatory using the inventive system 100 including the inflation means 150 attached to the retaining means 180 belt. This system is also less cumbersome than current post-operative compression systems which weigh many pounds on their own and other products on the market.

In another embodiment method of use of the inventive system 100, the system is used both prior to, during and after a lower body surgery. Particularly with lower leg joint replacement (knee and hip) surgery, there is an increased risk of DVT along with the pre- and post-op issues related to leg swelling. Due to the universal nature of the inflation port (or valve) on the inventive therapeutic compression apparatus, it can be coupled with a hand pump, a battery-operated pump, or the existing electrical intermittent pneumatic compression DVT systems that exist on the market. However, the sleeves to these existing DVT systems are not worn to reduce swelling, cannot apply compression in of a static nature, and cannot be used for mechanical DVT prophylaxis without the IPC DVT control unit. Thus, another method of use to improve the outcomes includes the steps of (a) at least 3 days pre-surgery, the patient is given the inventive therapeutic compression apparatus 200, 300, 500 to reduce limb volume and leg swelling, which can be achieved with either static or intermittent compression pressure levels, then (b) during surgery and immediately post-operative the inventive therapeutic compression apparatus 200, 300, 500 is connected to the IPC DVT control unit in the hospital or clinic or outpatient office setting, and the IPC cycles intermittently to provide standard DVT mechanical prophylaxis, and thereafter (c) as the patient is discharged, the patient is given the inventive therapeutic compression apparatus 200, 300, 500 to bring home along with either or both the hand compression pump or battery operated (or electrical powered) inflation means 150, such as pump 156, to manage the risk of DVT along with preventing further swelling.

It is envisioned, that the inventive system 100 could be used in conjunction with a lower leg compression apparatus (such as those described in U.S. Pat. Nos. 9,033,906 and 7,967,766 and 7,559,908 and 7,276,037 and U.S. Ser. No. 13,444,600), and one inflation means could be connected to each of the two compression apparatus as shown in FIGS. 1-21. The inflation means could include programming (not shown) connected to the sensors 197 (197A, 197B, 197C, 197D, 197E, 197F) such that the bladders of both the inventive therapeutic compression apparatus 200 and the bladder 202 or bladders 202A, 202B of the lower leg compression apparatus 200 are each (or together at the same time) inflated and deflated to a set pressure at intervals or at set times throughout the day or night when the compression apparatus is in use worn on the patient, whether sequentially or not. For instance, by way of example only, the inflation means 150 could be set to 40 mm-Hg at 9 am and then set to deflate to 20 mm-Hg at 11 am and then set to inflate to 30 mm-Hg at 12 μm and so on throughout the day and night for each patient individually. In another embodiment of the present invention, for instance, by way of example only, the inflation means could be set to 40 mm-Hg for a thigh bladder 300 and set to 20 mm-Hg for the lower leg bladder 202 (or calf bladder 202B or foot bladder 202A, etc.), or each could vary and the inflation means be set to sequentially inflate, deflate, inflate, or hold for a period of time, etc. throughout the day as described above. Depending on the treatment plan for the patient and depending on the specific patient, each of the bladders could be set to the same or different pressure levels though out the day and night. When inflated the inventive therapeutic compression apparatus 200 has a SSI of at least about 10 or greater.

In one embodiment of the invention, the inflation means includes a manual pump (as shown in FIGS. 2 and 8) and the dial includes graphics of pressure amount such as “35, “45’, “55’ and “65” or lettering such as “A”, “B”, “C”, “D” which each would correspond to a certain pressure such as 25 mm-Hg, 35 mm-Hg, 45 mm-Hg and 55 mm-Hg. The specific pre-determined pressure to correspond with the graphic is endless and not limited by the examples herein.

Further, the inventive therapeutic compression apparatus may be deflated by a button or a switch to deflate the bladder 202 (202A, 202B, 202C), 302 (302A, 302B), 502 and thus release the pressure and/or compression profile. In another embodiment (not shown), the switch may have a plurality of integrated umbrella valves so that one umbrella valve is set and closed to maintain the pressure within the bladder 202 (202A, 202B, 202C), 302 (302A, 302B), 502, while a second umbrella valve would release a certain amount of air or fluid within the bladder 202 (202A, 202B, 202C), 302 (302A, 302B), 502, so as to release the pressure such as while the patient is walking (pressure increases on the thigh with each step or on the foot portion of a lower leg inventive therapeutic compression apparatus) or flying (pressure increases based on altitude), and a third umbrella valve which would release all the air or fluid in the bladder 202 (202A, 202B, 202C), 302 (302A, 302B), 502, thus release all pressure and deflate the inventive therapeutic compression apparatus 200, 300, 500). For instance by way of example only, the first umbrella valve is set in a closed position so that when activated this umbrella valve maintains the amount of air or fluid in the bladder 202 and thus maintains the set pressure, say for instance at 45 mm-Hg, the second umbrella valve is set to release the air or fluid within the bladder 202 if the pressure within exceeds 45 mm-Hg and bring the pressure down to 45 mm-Hg (such as when in high altitude or other increases in pressure) and then maintain the pressure at 45 mm-Hg, and a third umbrella valve is set to open and release all the air or fluid within the bladder 202 and thus release all pressure when activated by the patient so as to deflate the bladder 202 and the inventive therapeutic compression apparatus 200. By way of another example, the dial or display 157 may include graphics such as (A) “Walk” wherein the set pressure amount is maintained while the patient walks and the pressure spikes and returns over and over in time as the umbrella valve remains in the closed position, (B) then a graphic of “Air” wherein the set pressure amount will be maintained by this umbrella valve occasionally releasing pressure as the pressure increases over the sci amount or value so that the umbrella valve is activated to release air or fluid within the bladder 202 and release the pressure yet then close and stay closed to maintain the set pressure amount, and (C) “Release” or “Deflate” wherein the pressure will be released and the air or fluid within the bladder 202 released to deflate and this umbrella valve is always in the open position. In this embodiment (not shown) there are three umbrella valves with one set to always open the bladder 202 to release pressure completely, one set to always close to maintain air or fluid in the bladder 202 to maintain pressure, and a third set to open or release at a predetermined or set pressure point. In all of the embodiments referring to umbrella valve the umbrella valve may also be a switch (manual or otherwise) or a digital switch or any other known means to open, close or partial release air or fluid within a bladder and thereby maintain, change or release pressure therein.

The inventive therapeutic system 100 includes an inventive sealing means connected to the bladder 202, 302, 502 so as to maintain the gradient compression profile and/or gradient pressure profile when the inflation means 150 is either disconnected from the inventive therapeutic compression apparatus 200, 300, 500 or the inflation means stops providing additional inflation or pressure. In one embodiment as shown in FIG. 2 the sealing means is a cap 213 which is inserted onto or into the inflation port 212, 209.

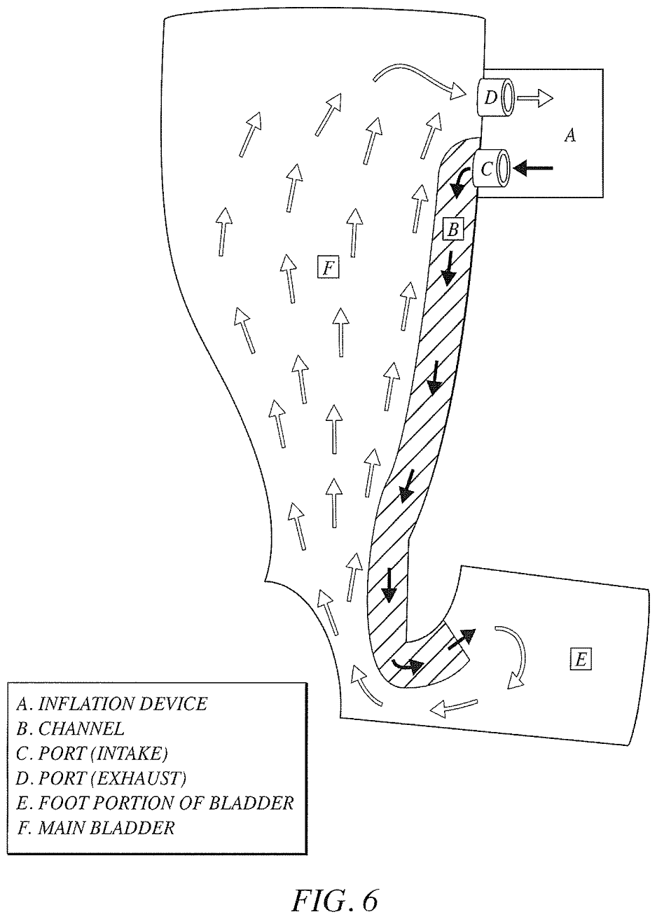

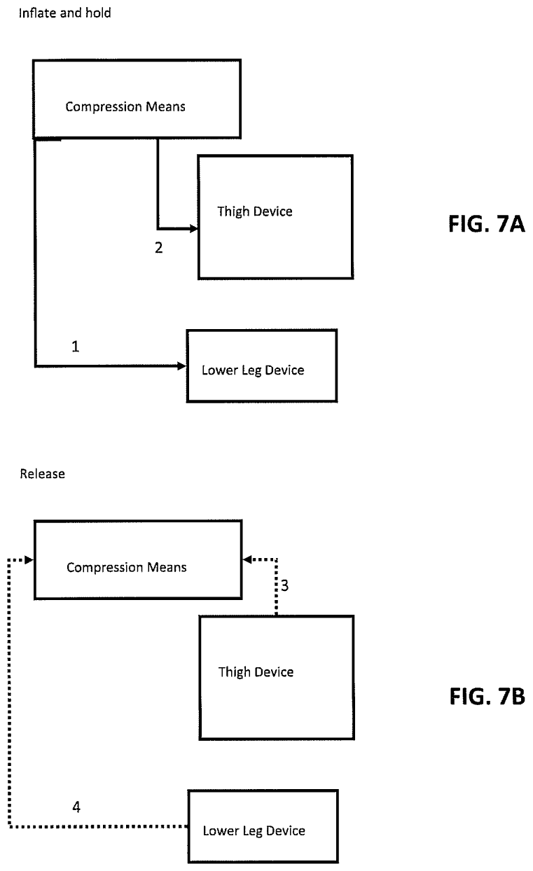

The sealing means also includes a valve 290 within the inflation port 212, 312 (212A, 212B, 212C), 312 (312A, 312B), 512. As shown in FIGS. 5A-5B which is a cut-away of the inflation port 212, the valve 290 is located within a housing 209, the housing being tubing or for instance a luer. In this embodiment the housing 209 is a plastic female luer but other materials can be employed such as metal, polymers, or rubbers and other housing means can be employed. The valve 290 as shown in FIGS. 5A and 5B includes a V-notch 291 in the top proximal portion of the valve 290 though other shapes of notches or other apertures and openings may be employed. The V-notch 291 in this embodiment assists in movement of the fluid from the male luer 161 (fluid flowing from the inflation means 150) into the inflation port 212 and into the bladder 202. The bottom distal portion of the valve 290 is in a shape as shown in FIGS. 5A and 5B such as a plug where the top portion 291 is thinner than the bottom distal portion and has a location 292 which abuts and seals the inflation port when it rests along the top portion 299 of the indent 293 in the lower portion of the housing 209. When the two portions 292 and 299 are connected or touching, the inflation port 212 is sealed and the fluid within the inventive therapeutic compression apparatus 200 is sealed within the bladder 202 and thus the pressure and compression within is sealed and if applicable the gradient compression profile and/or gradient pressure profile is maintained. As seen in FIGS. 5A and 5B, the housing 209 has a circumference which expands in a lower distal portion to house the valve 290. The shape as shown in FIGS. 5A and 5B is not limiting and any other shapes may be employed, as long as some portion of the valve 290 touches a portion of the housing 209 so as to create a sealing means and maintain the pressure and fluid within the inflated inventive therapeutic compression apparatus 200, 300. Again other shapes may be employed such that the functionality is created for a scaling means. The bottom distal portion 295 of the housing 209 in this embodiment then narrows or tapers so that when the valve 290 is pushed down by the male luer 161 the bottom of the valve 290 rest on top of 295 and the fluid passes around the outer circumference of the valve 290 and also through the V-notch 291 and flows into the bladder 202 via the opening or aperture 294. The outer circumference of the bottom distal portion of the valve 290 is slightly smaller than the inner circumference of the bottom distal portion 293 of the housing 209 so that the fluid can flow from the inflation means 150 through the hose 160 through the slip luer 161 through the inflation port 212 and into the bladder 202. The same components and method may be employed in the thigh inventive therapeutic compression apparatus 300 or any other type of inflatable apparatus.

FIG. 5A shows the inflation of the inventive therapeutic compression apparatus 200 with the male slip luer 161 inserted within the housing 209 of the inflation port 212 (the optional cap 211 is open and off to the side) and pushes down on the valve 290 so that the valve 290 bottom rests on the bottom distal portion 295 of the housing which is returned to as the open position for the valve 290. The fluid represented by the downward arrow in the middle of the male slip luer 161 flows into the housing 209 and past the valve 290 and into the bladder 202 as shown by the arrow direction in the bottom of the figure. The fluid will continue to flow into the bladder 202 until such time as the inventive therapeutic compression apparatus 200 is in the appropriate inflated state. The user then removes the male slip luer 161 inserted from the housing 209 of the inflation port 212 and the valve 290 moves in an upward direction so that the valve 290 bottom distal portion 292 touches the corresponding shape of the top portion 299 of the indent 293 in the lower portion of the housing 209. The two portions 292 and 299 are connected or touching thereby sealing the inflation port 212 and the fluid within the inventive therapeutic compression apparatus 200 is maintained at the level prior to the inflation means 150 being disconnected to inventive therapeutic compression apparatus 200. The fluid is represented by the upward arrow in the middle of the housing 209 flowing from the bladder 202 and into the bottom portion of the indented housing 293 is scaled by the valve 290. The inflation means 150 could be a manual pump 400 as well and any other static or intermittent inflation means. When the bladder 202 is deflated by the user the valve 290 will again be pushed down by the male slip luer 161 but no fluid or inflation will be employed at that time so that the fluid flows out of the inflation port past the valve 290 and the deflated state will be maintained. The valve 290 can be manually pushed down to deflate by inserting the male slip luer 161 or by a stem or other extending portion of the cap 211 (shown in FIG. 8K) or by any other appliance to push the valve 290 in a downward direction. In this embodiment the valve 290 is self-scaling but other sealing means can be employed such as any moveable lever, screw, switch, stop cock, or other mechanical means to seal the inflation port and maintain the fluid within.

The inventive system 100 may be included in a kit including an inventive therapeutic compression apparatus 200, 300, 500, an inflation means 150, a retaining means 180 such as a belt, and a connecting means such as a tube 160 (160A, 160B, 160C, 160D, 160E, 160F). The inflation means 150 may require a charger depending on the source of energy, such as an electric charger (not shown) for connecting to the USB port 159 and the kit would include such a charger. As seen in FIG. 3, a cable such as a USB cable 175 may be connected to the USB port 159 to charge the inflation means and the USB cable 175 has two connectors 176, 177 on each side for connecting to a charging source and connecting to the inflation means 150. As seen in FIG. 3 an optional battery 173 may be connected to the inflation means 150 and worn by the user on the belt 180. In this embodiment the battery assembly 170 includes a battery 172 placed within a pouch 171 or any other housing means and the pouch 171 is slipped onto the belt 180 via two openings or apertures 172 located on the sides of the pouch 171. The USB cable 175 is then connected on one side 1748, 177 to the battery 173 and connected on the other side 176 to the inflation means 150 at the corresponding USB port 159. The inflation means 150 may already be fully charged but with the optional battery 171 the user can leave the confines of hospital bed, home, work and is ambulatory and able to continue inflation without being tethered to an electrical outlet.

Depending on the inventive therapeutic compression apparatus 200, 300, 500 in the kit, a stocking or sock 110 or other layer between the patient's skins and the inventive therapeutic compression apparatus 200, 300, 500 may be included. Depending on the embodiment of the inflation means 150, a flexible cover 158 may be included in the kit. Other devices or apparatus may be included in such a kit or for instance, replacement or spare connecting means such as tubes 160, spare batteries 171, spare USB cables 173 and the like. The kit may also include various wound dressings and/or bandages. The wound dressings and/or bandages may be disposed of on a more frequent basis and the inventive therapeutic compression apparatus is applied in conjunction or combination with the wound dressings and/or bandages. In one embodiment the inventive therapeutic compression apparatus is used over or on top of the wound dressing applied to the skin.

Another embodiment of the present invention includes a method of applying a measured compression amount with feedback. In this embodiment (not shown), Compression Bladder A is inflated by Inflation Source C—the nature of Compression Bladder A is such that the amount of compression is determined by the amount of inflation medium (typically air) pumped into A from C. In this design, Inflation Source C is also coupled with Bladder B, which has a fixed volume of air. When Compression Bladder A inflates, it will squeeze Bladder Bas it compresses Compressed Item F. Inflation Source C is able to read the line pressure from the Coupling Line E to determine the interface pressure from Bladder B—in this design, Inflation Source C can be calibrated to provide only the amount of inflation medium necessary into Compression Bladder A as determined by matching the desired interface pressure from Bladder B. Other configurations may be employed so that feedback may be obtained from the inflation means and compression apparatus.

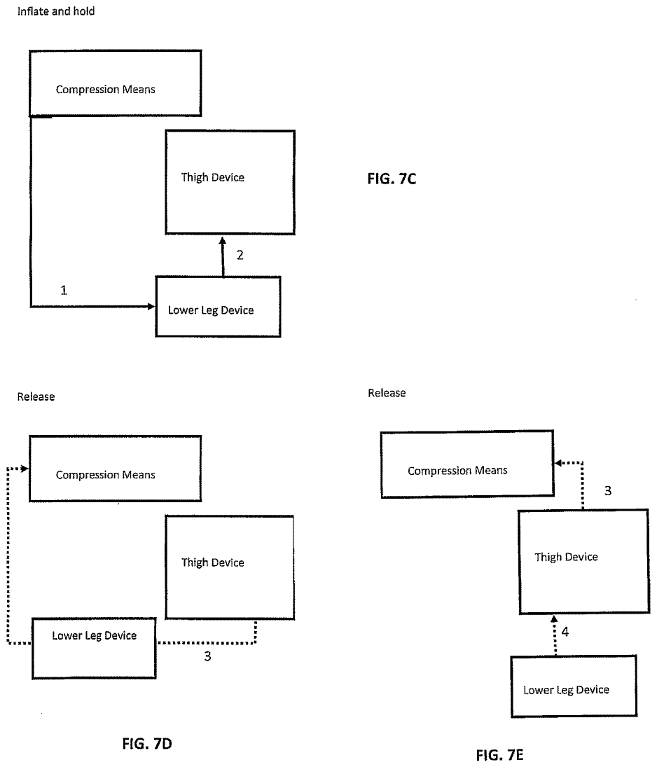

Another embodiment of the present invention includes a Sequential Gradient Compression with Single Chamber. In such embodiment (shown as FIG. 6), the inventive therapeutic compression apparatus 200 includes an inflation bladder to apply not only gradient compression but sequential (filling up either the channel B first and then filling up the main bladder V second, or the opposite) compression. In this embodiment (shown as FIG. 6), Inflation Device A is coupled to the device in two places (Intake Port C and Exhaust Port D). By inflating and providing air that goes directly into Channel R, the Channel B inflates first, before the Main Bladder F. Air then exits out of Exhaust Port D. In this design, the inflation can be intermittently provided for gradient and sequential compression or inflation can be held at a constant level to provide just the gradient profile.

The inflation means 150 may also include a sensor 155 to measure the air pressure being applied in the tube 160. Another embodiment of the present invention include an electric or other automated inflation means such that the bladder is inflated to a set volume or by reading the back pressure of which is being filled in. A pressure cycling function may be included. Further, an embodiment may have an inflation means such that the inflation maintains in the bladder(s) even after the inflation means is removed. Such inflation means may be integral to the compression apparatus itself or may be removable. Such inflation means may include an integrated circuit and/or wireless capability for tracking of usage, pressure, compliance by the patient in regard to maintaining certain pressures recommend by a physician or part of such patient's treatment plan, and other health data such as standing pressure and moving or working pressure, pedometer (number of steps), heartbeat, blood pressure and any other possible monitoring of the patient. Depending on the feedback obtained, the inflation means may be programmed to increase or decrease the pressure without manual changing by the patient. Further, the inflation means may be configured so that the physician or other treatment professional may increase or decrease the pressure remotely based on the feedback. Other combinations may be included such as manual changing of the dial or inflation means in combination with automated means or electric means or digital means.

The inventive system 100 may also include other sensors such as a tonometer, which is a device pressed into the skin to measure the amount of force required to make an indent in the tissue. The resulting measurement can help gauge the degree of firmness or fibrosis (tissue scarring) under the skin, which is a consequence of worsening lymphedema. Such a tonometer could be applied to the patient's skin under the inventive therapeutic compression apparatus 200, 300, 500 and measure the firmness or fibrosis at such treatment site on the limb of the patient. Such a tonometer could be connected to the inflation means via Bluetooth or other digital means and provide feedback to the patient and medical staff as discussed above.

As shown in FIGS. 20-21, the elastic portion 205 is inserted into the opening 204 to assist in better anatomical fit when in use on the individual person. Additional mesh inserts 217 may be placed within other apertures or openings 215 with the mesh or elastic portions 217 assisting in the anatomical fit as well as providing through areas to reduce or prevent excessive heat and sweating at the target limb when the inventive therapeutic apparatus 200 is wrapped and inflated on the user. Also shown are elastic portions 226 for the ankle area on the lower leg in these embodiments where the target limb is the lower leg. The elastic portion 226 assists in anatomical fit of the thinner ankle portion of the lower leg compared to the wider upper portion nearer the knee over the calf. The additional mesh or elastic inserts 217 also assist in anatomical fit over the calf area of the user's lower leg when the wrap 220 is closed and secured onto the lower leg, then inflated including maintaining a SSI of at least about 10 or greater.

The embodiment of the inventive therapeutic compression apparatus 200 as shown in FIGS. 1-2, 14-15 and 20-21 include an integrated foot wrap 250 including a hook and loop portions of 222, 224. In one embodiment the bladder 202 flows into the foot wrap 250 so that compression is located on the arch and under foot area corresponding with the arch of the user's foot whereas in other embodiments the bladder is separate so that the foot bladder 202A is separate from either one or two additional bladders 202B, 202C, and the foot bladder 202A is inflated from the inflation means 150 so that compression is located on the arch and under foot area. In these Figures the additional mesh or elastic inserts 217 are not included but they may be added to the wrap 220, just not shown here. The embodiment shown includes a heel aperture 230 and the elastic ankle portion 226. Another element which assists and reduces sweating and heating when the inventive therapeutic compression apparatus is inflated on the user's target limb are various through holes 208 located on lower leg inventive therapeutic apparatus 200, which are located on the hook and loop portions 222, 224 and the non-bladder portions of the wrap 220 and within the spot welds 214. The through holes 208, 308, 508 may be located throughout the inventive therapeutic compression apparatus 200, 300, 500 in order to allow for ventilation about a patient's leg, thigh, arm or other body part or limb during extended wear of inventive therapeutic compression apparatus 200, 300, 500. For the sake of clarity, not all of the through-holes are identified with reference characters in the Figures.

The sock or sleeve 110 is elastic and can include compression throughout, or only a portion having a compression element, or be non-compression. The elastic sock or sleeve 110 may be comprised of materials such as nylon, wool, cotton or any other compatible elastic material. The elastic sock or sleeve 110 may have a feature of compression itself which is then another level of compression coupled with the wrap 200, 220, 300, 500 and/or compression or pressure of the bladder 202 (202A, 202B, 202C), 302 (302A, 302B), 502 once inflated. In one embodiment as shown in FIGS. 20-21, the foot portion of the elastic sock or sleeve 110 includes a compression portion 112 located around the arch and sole of the foot portion. An optional compression strap (not shown) may be included which could have a loop portion and hook portion to secure the compression foot strap together. Other known connecting means for the compression strap may be included such as without limitation VELCRO™, hooks, snaps, adhesion, sewing, buttons, or the like. The elastic sock or sleeve 110 also includes a connecting means to connect to the inventive therapeutic compression apparatus 200, 300, 500 such as via adhesion, sewing, welding, gluing, snaps, hooks, buttons, Velcro™ or any other known connecting means. FIGS. 20-21 by way of example only show the connecting means as buttons 113 located on the elastic sock or sleeve 110 which can be inserted and secured within slits 223 on the apparatus 200. The number of connecting means 113 can be at least one but may be in an amount sufficient to connect the elastic sock or sleeve 110 to the wrap 200, 220. The area of elastic sock or sleeve 110 is connected or joined to the area (shown in FIGS. 20-21) on the inventive therapeutic compression apparatus 200 located above the along the calf portion and above the ankle area 226. Other embodiments could include VELCRO™ or loop and hook features. The ease of manufacturing, cost and use by the individual user, may affect the connecting means so that it may be a set of buttons wherein a male portion of the button 113 located on the elastic sock or sleeve 110 which mates to the female opening portion 223 located on the therapeutic compression apparatus 200. In this embodiment the female opening portion 223 is a slit aperture but it could be any other type of aperture or if the connecting means was a snap it would be the combination of the female and male portions of the snap. Other connecting means could include snaps, hooks, buckles, straps, zippers and other combinations of known connecting means.

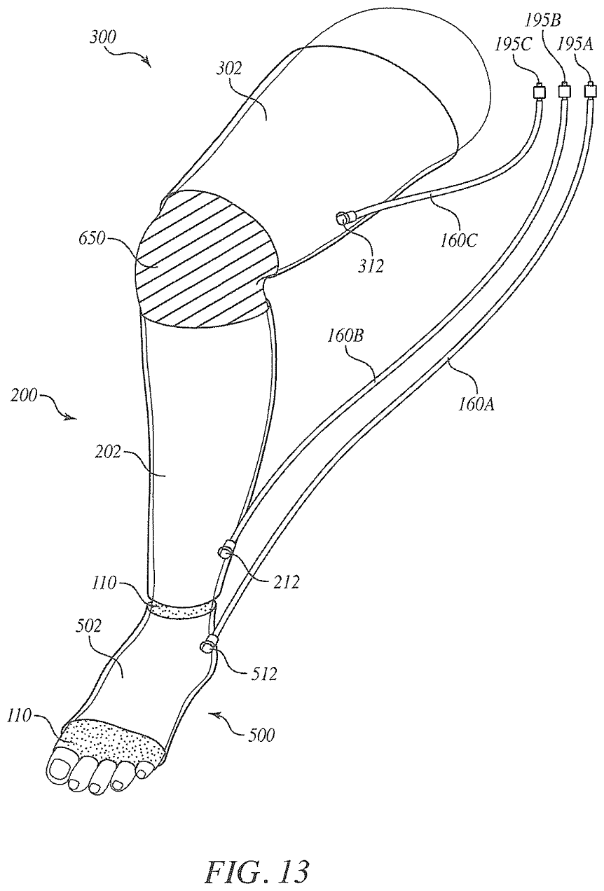

In yet another embodiment of the present invention as shown in FIG. 13, the inventive therapeutic compression apparatus has two wraps and bladders 202, 302 connected y an elastic knee sleeve 650 so that the apparatus is a full leg apparatus. Also shown is a separate inventive foot therapeutic compression apparatus 500 connected to the same inflation means 150 as the full leg therapeutic compression apparatus. In this embodiment, the single inflation means can sequentially inflate, hold, deflate and other combinations of each of the multiple connected bladders 202, 302, 502. By way of non-limiting example only, bladder 502 could be inflated then held, followed by bladder 202 inflated then held, followed by bladder 302 inflated then held, followed by bladder 502 deflated for a period of time, followed by bladder 202 deflated for a period of time, followed by bladder 302 deflated for a period of time, and then the cycle repeated for a period of time. This method of inflation and deflation, and holding pressure where applicable, can be employed in all the embodiments shown and not shown.

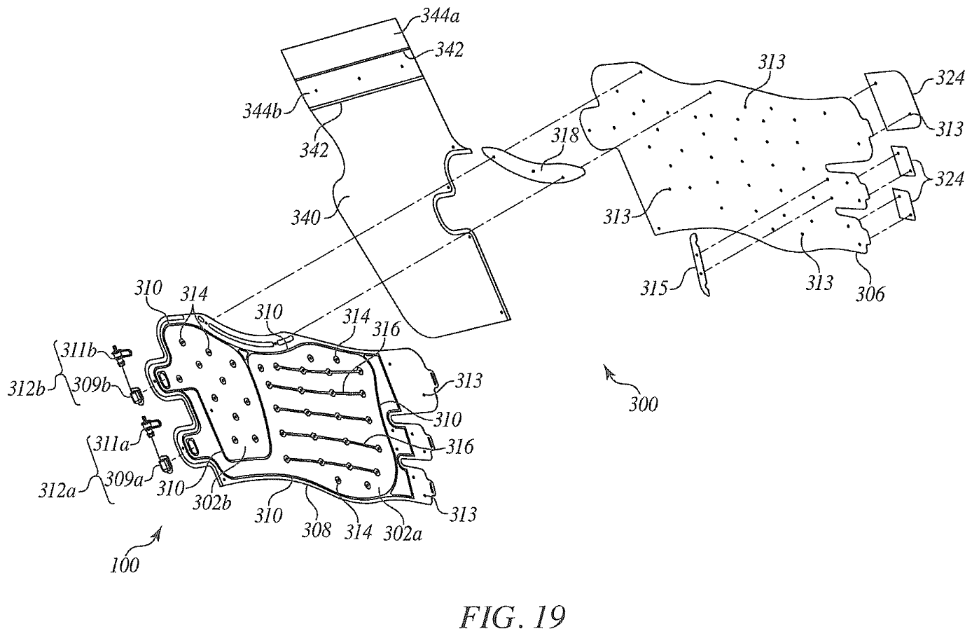

Further, optional supports may be included on each inventive therapeutic compression apparatus 200, 300, 500 to reduce tearing of the wrap 220 or hook 222 when pulling the hook portion 222 off the loop portion 224. As seen in FIG. 19, a series of strain relief portions 221 are included between each of the hook portions 222 to reduce tearing of the material after repeated use by the individual. These optional strain relief portions 221 may be a connector to strengthen the area between the hook fastener 224 to prevent tearing of the material when in constant use by the individual.

The SSI of the inventive therapeutic compression apparatus 200, 300, 500 when inflated may be measured by known methods, such as measuring the pressure and the Picopres by way of example only. In one such measurement by way of example, the inventive therapeutic compression apparatus 200, 300, 500 was placed on an individual's lower leg, wrapped on the leg and inflated to the three different pressure or compression readings below. The Picopres was measured showing a SSI of at least 12 or greater:

| AeroGauge (mm Hg) | Pressure by Picopress (mm Hg) | |
|---|---|---|
| Right leg | | |
| 20-30 | 38 supine | 53 standing |
| 30-40 | 45 | 63 |
| 40-50 | 48 | 68 |
| Left leg | | |
| 20-30 | 38 | 56 |
| 30-40 | 44 | 72 |
| 40-50 | 54 | 89 |

In another embodiment, the inventive therapeutic compression system 100 has sensors that measure the positioning and movement of the inventive therapeutic compression apparatus 200, 300, 500. Such sensors could be interpreted to give readouts (via the interface, a plug-in to a computer, or sent to an app) to the user or clinician as to the compliance, activity (pedometer to measure steps, stairs climbed, etc.), and give advice/alerts to improve the treatment. In one such embodiment with sensors, the inventive therapeutic compression apparatus 200, 300, 500 would be programmed to automatically adjust the type and level of compression administered—for example, it is known in the art that while walking static compression is adequate for lower-leg compression therapy so if the sensors detect that the user is walking it would maintain a static, non-intermittent compression of the garment. If the sensor senses that the lower leg is not walking and is at rest it could either alert the user to switch to intermittent compression or could automatically switch over to intermittent compression to promote blood flow. In one embodiment the sensors would be able to measure skin fibrosis and adjust the level of compression required to improve swelling reduction. These sensors listed are not limiting and any other known or future developed sensors could be employed with the inventive system.

The sensors described above are non-limiting and could be non-digital or digital means may also be employed. A motorized pump and digital display may be used. The valve may include digital or electric means to change or modify pressure at a set rate or intervals or based on feedback from the monitoring means. The system may include various sensors and monitors. Other sensors could be time set for instance if the system was rented so that the system would stop working once the sensor triggered that the rental days or rental hours had expired. In this instance, the sensor could be reset if additional rental time was purchased.

The inventive therapeutic compression system 100 may be used to treatment a patient post-operation, such as post-operative sclerotherapy procedures. Post-operative sclerotherapy treatment can also be effective with thigh inventive therapeutic compression apparatus 300 wherein a lateral bladder is closed via a closing means (shown as weld lines 316 in FIG. 19) and either remains in a non-inflated state or may be slightly inflated to a lower pressure level, or could be inflated to any pressure level desire by the patient. In this embodiment, a medial bladder is inflated as part of the post-operative treatment plan to apply compression and pressure to the treatment site. Reference is made to U.S. patent application Ser. No. 16/846,211 filed on Apr. 10, 2020, which is incorporated herein. Other post-operative procedures may employ the same method. The two bladders 302A, 302B within the thigh inventive therapeutic compression apparatus 300 with the lateral bladder 302B separate from the medial bladder 302A. The lateral bladder 302B may be inflated at manufacture to a set pressure level or not inflated and remain in an uninflated state when in use, he lateral bladder 302B is connected to the inflation means 150 via an inflation port 302B and hose 160 (160B or as applicable 160C, 160D, 160E, or 160F or higher depending on the total number of separate bladders on the user subject to the sequential compression), and the lateral bladder 302B may have a different pressure level than the pressure within the medial bladder 302A. As shown in FIG. 19, the lateral bladder 302B can be separately inflatable or inflatable through an inflation means 150 including port 312A (309A), 311B, such as but not limited to a one-way valve or other desired inflation/deflation configuration. The lateral bladder 302B can also be configured and adapted to provide a differing pressure from the medial bladder 302A. For example, when employing the thigh inventive therapeutic compression apparatus 300 after sclerotherapy surgery, the lateral bladder 302B is separate and not connected to the medial bladder and thus in this embodiment, the medial bladder 302A is inflated as part of the post-operative treatment plan to apply a certain predetermined gradient compression profile and pressure to the treatment site while a different predetermined gradient compression profile and pressure may be applied to the back or lateral portion of the user's thigh.

The inventive therapeutic compression system 100 may be used for other treatments such as tissue swelling, arterial and/or venous ulcers, lymphedema, CVI, DVT or any other vascular related issue. In use the inventive therapeutic compression apparatus 200, 300, 500 may be placed by the patient, practitioner or caregiver on the chosen limb, such as for instance the leg and fastened around the limb of the patient. Moving in an upward or downward position from the knee and/or hip and/or foot, the patient, practitioner or caregiver fastens or secures the fastening tabs up or down to the limb. If there are additional optional straps located on the proximal end of the apparatus the first strap should be closed or secured in a tight fashion so that the inventive therapeutic compression apparatus 200 fits snugly but not too tight and the second strap should be closed or secured in a tight fashion so that the inventive therapeutic compression apparatus 200 fits snugly but not too tight. The patient, practitioner or caregiver then removes the valve cap 213 from the valve located on the inventive therapeutic compression apparatus 200 thus opening the inflation port 212 (212A, 212B), namely the female slip luer 209. The patient, practitioner or caregiver then selects a pressure amount of value on the display 157 or dial of the inflation means 150 depending on the treatment and whether the patient will be walking, sitting, lying down or traveling in a vehicle, train or airplane. Once the pressure amount or value is chosen on the dial (such as a given pressure amount such as “35” mm-Hg or a text such as “Walk” or “Air” or “Travel” or “Low” or “Medium” or “High”), the corresponding umbrella valve or switch is activated such that the pressure is thereafter maintained (closed position) or modified so as to maintain the pressure as it changes with the activity or altitude when in use). The patient, practitioner or care-giver then inserts an end of the tube 160 portion such as the male luer slip 161 into the inflation port 212 on the inventive therapeutic compression apparatus 200, presses the ON-OFF button 149 of the inflation means 150 or uses the hand pump 165, and the air or fluid is increased to inflate the bladder 202 and thus achieve a desired pressure amount or valve. Again this inflation means may be a hand pump, electric pump, battery-operated pump, remote controlled pump, air pump, gas pump, or any other known inflation means. A number or variety of inflation means can be employed such as a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient. Depending on the inflation: means employed such inflation means may be removed and the valve cap replaced and the pressure will not decrease except as noted in the “Air” or “Walk” position. At any point in use the patient, practitioner or care-giver can deflate the bladder by either inserting the valve cap so it depresses the valve spring and thus release the air or fluid in the bladder and decrease the pressure, or the patient, practitioner or care-giver can reinsert the inflation means and select the “Deflate” or “Release” and the corresponding umbrella valve will be in the open position so as to release the air or fluid in the bladder and decrease the pressure until a deflated state is achieved for the bladder and the inventive therapeutic compression apparatus. The inventive therapeutic compression apparatus can be reinflated and deflated; over and over again when in use. When inflated the inventive therapeutic compression apparatus 200, 300, 500 has a SSI of at least about 10 or greater.

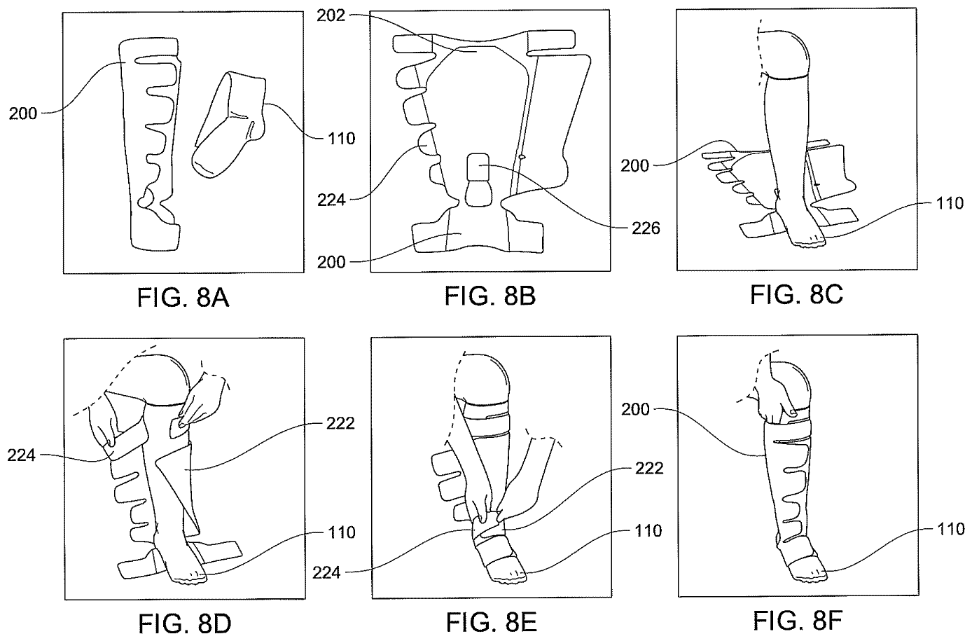

The method of use of the inventive system is also described in FIGS. 7A and 8A-8K. The present invention has been illustrated and described with respect to specific embodiments thereof, which embodiments are exemplary and illustrative of the principles of the invention and are not intended to be exclusive or otherwise limiting embodiments. For instance, while in the foregoing embodiments. The therapeutic compression apparatus 200 are described as having inflatable bladders, the therapeutic compression apparatus 200 may additionally include integrally formed or attached (e.g., by adhesive, radio-frequency welding, etc.) compression members that are not configured for inflation and/or deflation. For instance, additional compression members may be implemented using any of a variety of preformed and/or prefilled cushioning materials such as foam cushions and/or air, gel, or other fluid filled non-inflatable cushions, provided such compression members generate sufficient compression in combination with integral compression bladders. Further, while particular shapes, sizes, and materials have been described for purposes of illustration, it will be recognized that any of a variety of shapes or sizes can be used, and the materials described are not exclusive but merely illustrative. Also, as noted above, while the bladder shown is inflated with air, it will be appreciated that any other fluid or medium such as liquid or gel can be used. Moreover, as also noted, it will be understood that bladders may be configured to have multiple pneumatically independent and/or pneumatically coupled bladder sections and may also be configured to have various contours or lobulations.

The inventive therapeutic compression system 100 described herein can be used for any suitable condition treatable by compression therapy and the like. For example, the inventive system including a therapeutic compression apparatus 200 in accordance with the present invention can be used for compression of the venous system for the treatment of swelling, venous and arterial ulcers, CVI, DVT, for the treatment of lymphedema (where it is circulation of fluids in the lymph system rather than in the venous system that is promoted), and the like. Notably, the inelastic portion having a SSI of greater than about 10 assists in such treatment as well as the elastic portion making sure no compression or pressure is lost due to the inventive therapeutic compression apparatus 200, 300, 500 slipping down due to gravity and the user moving or walking, and reduces or eliminates a gap between the user's anatomy such as the hup, groin, knee or ankle and the actual inventive therapeutic compression apparatus 200, 300, 500.

As shown in FIG. 2, the method of use could include two or three therapeutic compression apparatus connected to one inflation means. In this example, the thigh therapeutic compression apparatus 300 and the two lower leg therapeutic compression apparatus 200 are each separately connected to the inflation means via two tubes or hoses, each tube connected on one end to a therapeutic compression apparatus and the other end to the inflation means. The method includes wherein (1) the inventive thigh therapeutic compression apparatus is placed on the thigh area with the elastic portion 317 along the groin area and the inventive lower leg therapeutic compression apparatus 200 is placed on the lower leg with the elastic portion 204 along the upper portion of the calf area below the knee and each is secured on the limb with the hook and loop 322, 324, 222, 224, (2) the lower leg therapeutic compression apparatus 200 is inflated first and holds at a determined pressure level, then (3) the thigh therapeutic compression apparatus 300 is inflated and holds at a determined pressure level, then (4) the thigh therapeutic compression apparatus 300 is deflated either entirely or just to a lower pressure level, and thereafter (5) the lower leg therapeutic compression apparatus 200 is deflated either entirely or just to a lower pressure level. In this example the pressure level could be either constant static status or an intermittent varying pressure status. Further, in this example the pressure levels can be either the same or different or the line pressure can be the same but the interface pressure can be adjusted with the shaping of each of the bladders (whether shape or combination of spot welds and/or line welds to form a gradient pressure profile).

In an alternate method (not shown), after inflation steps (1) and (2) the (3) the thigh therapeutic compression apparatus 300 is deflated either entirely or just to a lower pressure level, and thereafter (4) the one or both lower leg therapeutic compression apparatus 200 is deflated either entirely or just to a lower pressure level. In yet another alternate method (not shown), after inflation steps (1) and (2) then (3) the lower leg therapeutic compression apparatus 200 is deflated either entirely or just to a lower pressure level, and thereafter (4) the thigh therapeutic compression apparatus 300 is deflated either entirely or just to a lower pressure level. In all of these examples of FIGS. 2 and 7A-7D the pressure level could be either constant static status or an intermittent varying pressure status. Further, in this example the pressure levels can be either the same or different or the line pressure can be the same but the interface pressure can be adjusted with the shaping of each of the bladders (whether shape or combination of spot welds and/or line welds to form a gradient pressure profile). Finally, the order of first inflation could be reversed in that the tube from the inflation means could be connected to the thigh therapeutic compression apparatus 300 and then a tube connects the thigh therapeutic compression apparatus 300 and the lower leg therapeutic compression apparatus 200 so that the thigh therapeutic compression apparatus 300 is inflated first, followed by the lower leg therapeutic compression apparatus 200 and then the lower leg therapeutic compression apparatus 200 is deflated (partially or entirely) followed by deflation of the thigh therapeutic compression apparatus 300. Other variations may be made if the first therapeutic compression apparatus is an arm or hip or torso therapeutic compression apparatus followed by the thigh therapeutic compression apparatus 300 or a lower leg therapeutic compression apparatus 200 and any other combination of another limb therapeutic compression apparatus.

In an alternate method (not shown), after inflation steps (1) and (2) the (3) the thigh inventive therapeutic compression apparatus 300 is deflated either entirely or just to a lower pressure level, and thereafter (4) the one or both lower leg inventive therapeutic compression apparatus 200 is deflated either entirely or just to a lower pressure level. In yet another alternate method (not shown), after inflation steps (1) and (2) then (3) the lower leg inventive therapeutic compression apparatus 200 is deflated either entirely or just to a lower pressure level, and thereafter (4) the thigh inventive therapeutic compression apparatus 300 is deflated either entirely or just to a lower pressure level. In all of these examples of FIGS. 2 and 7A-7D the pressure level could be either constant static status or an intermittent varying pressure status. Further, in this example the pressure levels can be either the same or different or the line pressure can be the same but the interface pressure can be adjusted with the shaping of each of the bladders (whether shape or combination of spot welds and/or line welds to form a gradient pressure profile). Finally, the order of first inflation could be reversed in that the tube from the inflation means could be connected to the thigh inventive therapeutic compression apparatus 300 and then a tube connects the thigh inventive therapeutic compression apparatus 300 and the lower leg inventive therapeutic compression apparatus 200 so that the thigh inventive therapeutic compression apparatus 300 is inflated first, followed by the lower leg inventive therapeutic compression apparatus 200 and then the lower leg inventive therapeutic compression apparatus 200 is deflated (partially or entirely) followed by deflation of the thigh inventive therapeutic compression apparatus 300. Other variations may be made if the first inventive therapeutic compression apparatus is an arm or hip or torso inventive therapeutic compression apparatus followed by the thigh inventive therapeutic compression apparatus 300 or a lower leg inventive therapeutic compression apparatus 200 and any other combination of another limb inventive therapeutic compression apparatus.

As shown in another embodiment of the method of use includes one inflation means, one tube or hose connected to the inflation means and the first inventive therapeutic compression apparatus (in this instance the lower leg inventive therapeutic compression apparatus 200), a second tube connected to the first and second or third inventive therapeutic compression apparatus (in this instance a third inventive therapeutic compression apparatus 300) and then a tube or hose connected to an exhaust port in the inflation means and the second inventive therapeutic compression apparatus (in this instance a thigh inventive therapeutic compression apparatus 300). In this example, the thigh inventive therapeutic compression apparatus 300 and the lower leg inventive therapeutic compression apparatus 200 are connected to the other via a tube or hose and one inventive therapeutic compression apparatus (in this instance the lower leg inventive therapeutic compression apparatus 200) is connected to the inflation means via a separate second tube or hose and a third tube or hose connects the second inventive therapeutic compression apparatus (in this instance the thigh inventive therapeutic compression apparatus 300) to the inflation means or an exhaust port. The method as shown in FIGS. 7A-7C includes wherein (1) the lower leg inventive therapeutic compression apparatus 200 is inflated first and holds at a determined pressure level, then (2) the thigh inventive therapeutic compression apparatus 300 is inflated and holds at a determined pressure level which inflation is administered via a tube or hose connecting the thigh inventive therapeutic compression apparatus 300 and the lower leg inventive therapeutic compression apparatus 200, then (3) the thigh inventive therapeutic compression apparatus 300 is deflated (either entirely or just a lower pressure level) via a tube or hose connected to an exhaust port or release port in the inflation means and thereafter (4) the lower leg inventive therapeutic compression apparatus 200 is deflated (either entirely or just a lower pressure level). In an alternate method (not shown), after inflation steps (1) and (2) then (3) the lower leg inventive therapeutic compression apparatus 200 is deflated either entirely or just to a lower pressure level, and thereafter (4) the thigh leg inventive therapeutic compression apparatus is deflated either entirely or just to a lower pressure level. In yet another alternate method (not shown), after inflation steps (1) and (2) then (3) the lower leg inventive therapeutic compression apparatus 200 and the thigh inventive therapeutic compression apparatus 300 are both deflated at the same time, either entirely or just to a lower pressure level. While in this example of the method of use the second inventive therapeutic compression apparatus is connected to an exhaust port or release port in the inflation means, oilier embodiments may employ an exhaust port or release port integral to the inventive therapeutic compression apparatus themselves, such as part of or near the inflation port 212, 312 in an inventive therapeutic compression apparatus 200, 300. In all of these examples of FIGS. 7A-7C the pressure level could be either constant static status or an intermittent varying pressure status. Further, in this example the pressure levels can be either the same or different or the line pressure can be the same but the interface pressure can be adjusted with the shaping of each of the bladders (whether shape or combination of spot welds and/or line welds to form a gradient pressure profile). Finally, the order of first inflation could be reversed in that the tube from the inflation means could be connected to the thigh inventive therapeutic compression apparatus 300 and then a tube connects the thigh inventive therapeutic compression apparatus 300 and the lower leg inventive therapeutic compression apparatus 200 so that the thigh inventive therapeutic compression apparatus 300 is inflated first, followed by the lower leg inventive therapeutic compression apparatus 300 and then the lower leg inventive therapeutic compression apparatus 200 is deflated (partially or entirely) followed by deflation of the thigh inventive therapeutic compression apparatus 300. Other variations may be made if the first inventive therapeutic compression apparatus is an arm or hip or torso inventive therapeutic compression apparatus followed by the thigh inventive therapeutic compression apparatus 300 or a lower leg inventive therapeutic compression apparatus 200 and any other combination of another limb inventive therapeutic compression apparatus.

As shown in FIGS. 8A-8K, a method of use of the inventive therapeutic system 100 is shown in one embodiment where the user takes the lower leg therapeutic compression apparatus 200 and the sock 110 and places the sock 110 on the lower leg. The user then places the lower leg therapeutic compression apparatus 200 on the leg connecting the buttons 113 on the sock or sleeve 110 into the apertures 223 and making sure that the elastic portion 204 fits snuggly and conforms to area below the knee on the back of the leg, then connects the upper part of the hook and loop 222, 224 followed by the foot portion 222, 224 and then the middle of the lower leg 222, 224. The user checks to make sure there is room for inflation and gradient compression such as places two fingers between the sock 110 and the therapeutic compression apparatus 220. The user then chooses either the inflation means 150 of powered pump 165 or a manual hand pump 400. If choosing the manual pump the user chooses the pressure range on the dial 410, inserts the male slip luer 161 into the inflation port 212, specifically the female luer 209, and then pumps the bulb 420 until the therapeutic compression apparatus is inflated and then removes the male slip luer 161 which triggers the valve 290 to move in an upward direction and seals the bladder 202. If choosing the pump 156 in this embodiment the user puts on the securing means of the belt 180, adjusts it using the adjusters 182, and then buckles it using 185A, 185B. The user then opens the cap 211 and inserts male slip luer 161 into the inflation port 212, specifically the female luer 209, and then presses the pump 156 on, possibly choosing a set pressure amount (static or intermittent) and once the therapeutic compression apparatus is inflated, removes the male slip luer 161 which triggers the valve 290 to move in an upward direction and seals the bladder 202. In both instances the user can place the cap 211 on top of the female slip luer 209 to further seal the bladder 202. To deflate, the user then can remove the cap 211, invert it and push the stem into the female slip luer 209 to release the seal and deflate the bladder 202, The user can also deflate using the hand pump dial 410 or putting the pump 156 off or set to a deflate position on the pump 156. Other methods of inflation and deflation may also be employed. When inflated the inventive therapeutic compression apparatus 200 has a SSI of at least about 10 or greater and the elastic portion 204 conforms to the anatomy of the knee such that the inventive lower leg therapeutic compression apparatus 200 has uniform compression and pressure along the entire lower leg and even the upper calf area so as to eliminate a gap at that anatomical area and the inventive lower leg therapeutic compression apparatus 200 can assist in treating, reducing and even preventing tissue swelling, lymphedema, venous and arterial ulcers, CVI and DVT as well as improve circulation at the foot and lower leg and upper leg of the user.

As stated herein, the possible therapeutic compression apparatus to be used in the inventive system are only limited to the target limbs or body part to be compressed or subject to pressure treatments in order to improve circulation and reduce and treat tissue swelling, lymphedema, CVI, DVT, arterial and/or venous ulcers or any other medical issue as well as improve and treat circulation disease or problems in the foot, calf, lower and upper leg as well as other body parts such as wrist, arm, torso, shoulder and any other target area on the patient or user. For instance, the therapeutic compression apparatus could be for a foot, ankle, calf, lower leg, knee, thigh, groin, hip, buttocks, torso, stomach, back, shoulder, chest, arm, elbow, wrist, hand, neck, head, or the like and any combinations thereof. The inventive system of the instant invention described herein solves many problems with the prior art and in the industry and treatment of patients. The therapeutic compression apparatus 200, 300, 500 may be applied on the patient's body part by the patient without the need or requirement of a skilled caregiver as required by current devices and apparatus. It further is capable of maintaining sufficient effective pressure without overpressure complications, maintaining compression and pressure and the like.

The inventive therapeutic compression apparatus 200, 300, 400 of the instant invention of the therapeutic compression system 100 includes a universal inflation port which is configured to be capable of connecting to more than one source of compression or inflation means such that the patient could vary treatment through varying the inflation source and inflation means for the treatment apparatus or device. For instance, a patient using the inventive therapeutic compression apparatus 200, 300, 500 of the instant invention can alternate between a manual or mechanical or electrical inflation means or source of inflation and pressure. Further, the patient can alternate between static or intermittent inflation and pressure when using the inventive system and inflation means 150 pumps.

The inventive therapeutic compression system 100 also reduces the problem of lack of mobility in that the inflation means is not integral to the inventive therapeutic compression apparatus and instead the patient can walk about and go to work, school, recreational activities. The inventive system 100 includes inflation means which is not tethered to a wall outlet and instead is a main pump which is configured to either apply constant static pressure at one pressure level, or constant at static pressure at a choice of different pressure levels, or intermittent pressure at one level, or intermittent pressure at multiple pressure levels, or a choice of either constant static pressure level and intermittent pressure levels. The ability to switch between pressure levels and/or switch between constant static pressure and intermittent pressure promotes a more effective treatment for CVI, DVT and/or lymphedema, tissue swelling, poor and decreased circulation, arterial and venous ulcers and other treatments.

Another embodiment (not shown) may include a variety of sensors so that the pump on its own may adjust the pressure level or switch from intermittent pressure level (which the patient is sitting or the kg is elevated) to constant static pressure (when the patient is walking or running). Such sensors may be connected to a database accessible by a medical provider which could remotely adjust the pressure levels or status change from intermittent to constant or the reverse.

The inventive system 100 may be used as a prophylaxis or as part of a treatment plan which is easy for the patient to use at home or work (outside a hospital setting or with the aid of a medically trained professional as noted above) which is ambulatory so that the patient can walk and return to life activities. The inventive system can be used as a prophylaxis for swelling in any body part. The system can also be used in pre-operative and post-operative treatments for many different surgeries including but not limited to knee surgeries, hip surgeries, TKR, KRA, n-m., HRA, sclerotherapy and many other surgical procedures regarding other libs or body parts which could have an increased risk of CVI and/or DVT. The inventive system 100 may be used to prevent, reduce or even treat DVT and the system is practical to use, mobile and easy to be administered by the patient post-operative total knee replacement of any other knee, hip or leg surgery. Further the inventive system could also be used in HPIC treatment and this inventive system can be easily administered by a patient in the home setting as well as a rehabilitation setting or nursing home setting as it allows the patient to be ambulatory.

The inventive system includes an inflation means which is less bulky than known systems. The user can thus return to life activities sooner than with known compression systems, prophylaxis systems and other treatment systems which limit the user's ambulation both within and outside the home due to power constraints (electrical, mechanical, battery, manual, etc.) on the system. Further, the inventive system may include one or more sensors to measure the user's limb in regard to pressure on the skin, motion of the limb, blood pressure, tonometer sensor, GPS sensor, and the like while the system is in use. Such sensors may be connected to the inflation means so as to regulate the pressure from the inflation means and either increase or decrease the current pressure level(s). Such sensors may also be connected to a database and possibly accessible to a medical professional and/or the user in real time or as saved over time.

Additionally the system includes multiple of compression garments which each inventive therapeutic compression apparatus may have separate active pressure levels at the same time or can vary over time and based on the user's activities as well as individual bladders 202A, 202B, 202C, 302A, 302B, 502 may have separate active pressure levels at the same time or can vary over time and based on the user's activities.

Additionally the inventive therapeutic compression system 100 includes multiple of compression apparatus 200, 300, 500 with each therapeutic compression apparatus 200, 300, 500 may have separate active pressure levels at the same time or can vary over time and based on the user's activities. Notably, the inventive therapeutic compression apparatus 200, 300, 500 has a SSI of at least about 10 or greater for the inelastic portion (whether including a bladder or no bladder) while the elastic portion conforms to the anatomy of the user reducing or eliminating a gap or opening between the limb and the inventive therapeutic compression apparatus 200, 300, 500 (which such gap or opening would reducing the compression or pressure on the user thereby reducing the effectiveness of the treatment) and therefore there is increased or more uniform compression and pressure along the entire target limb such as the lower leg and even the upper calf area. The inventive therapeutic compression apparatus 200, 300, 500 including an elastic portion reduces or eliminates a gap at that anatomical area (such as the ankle, foot, knee, groin, hip, wrist, elbow, shoulder, sacral, neck, and other areas along the target limb) and thus the inventive therapeutic compression apparatus 200, 300, 500 can assist in treating, reducing and even preventing tissue swelling, lymphedema, venous and arterial ulcers, CVI and DVT as well as improve circulation at the target limb such as the foot and lower leg and upper leg of the user. The inventive therapeutic compression apparatus 200, 300, 500 includes an inelastic portion (with or without an inflated bladder) having a SSI of greater than about 10, in the range of about 10 to about 50, and an elastic portion configured to confirm to a target body area such as a foot, ankle, knee, groin, hip, wrist, elbow, shoulder, torso, sacral, neck and any other body part.

The inventive therapeutic compression apparatus 200, 300, 500 may have one set level of pressure or compression such as shown in FIGS. 9-10 and 13 or may employ gradient compression as shown in FIGS. 1-2, 11, 14-15 and 20-21 which is particularly effective with more pressure being applied more distally (further) from the heart with the pressure reducing proximally (closer). This helps to squeeze the body in a manner to help spur circulation and reduce the limb size such as on the foot, calf, lower and upper leg areas. The inventive therapeutic compression apparatus 200, 300, 500 (whether set or gradient compression) in use assists in reducing the tissue swelling and water volume within the limb to manage the amount of leg swelling. As well as improving circulation of blood and fluid, particularly when the user walks around as compression squeezes the circulatory system into better contact with the muscles (for example, calf with lower-leg compression) to improve the body's efficacy of fluid movement. The inventive therapeutic compression apparatus 200, 300, 500 is more effective than known compression stockings, sock, bandages and even devices as it applies compression and a static stiffness index of at least greater than 10 to improve venous hemodynamics and reduce edema because (not being bound by theory) of the underlying stiffness and elasticity of the inventive therapeutic compression apparatus 200, 300, 500. It overcomes the many disadvantages of the known and conventional compression products.

Further, the inventive therapeutic compression apparatus 200, 300, 500 overcomes the problems of known and conventional compression products that do not have sequential inflation and deflation thereby reducing the dynamic compression effect, but in contrast the inventive therapeutic compression apparatus 200, 300, 500 includes sequential compression by inflating and deflating the bladders 202, (202A, 202B, 202C), 302 (302A, 302B), 502. The inventive therapeutic compression apparatus 200, 300, 500 solves this and other problems by maintaining and improving both static and dynamic compression for the treatment of arterial ulcers, venous ulcers, poor circulation, tissue swelling, lymphedema, CVI and DVT.

While the subject invention has been described with respect to the preferred and exemplary embodiment, those skilled in the art will readily appreciate that various changes and/or modification can be made to the invention without departing from the spirit and scope of the invention as described herein. There have been describe and illustrated herein several embodiments and particular embodiments of the invention have been described, it is not intended that the invention be limited thereto, as it is intended that the invention be as broad in scope as the art will allow and that the specification be read likewise. Thus, while particular shapes and sizes of inflatable bladders and straps have been disclosed, it will be appreciated that other shapes, sizes, and attachment means may be used as well. It will therefore be appreciated by those skilled in the art that yet other modifications could be made to the provided invention without deviating from its spirit and scope as claimed.

We claim:

1. A therapeutic compression system for applying pressure to at least one limb of the human body, comprising:
at least one wrap configured to be worn on a limb of a user including two inelastic layers joined to form at least two bladders, each bladder connected to a separate universal inflation port configured to be capable of connection to a static or intermittent inflation means;
a connecting means from each universal inflation port to the inflation means having a distal and proximal end with a insertion portion on the distal end configured to insert into an aperture in a manifold on the inflation means; and
at least one sensor configured to inflate, hold or deflate each of the bladders at a chosen pressure level or time period,
wherein the universal inflation port includes a sealing means configured to include an open position and a closed position wherein the closed position maintains the at least one bladder in an inflated or deflated state and is in the open position when coupled to the inflation means so that the at least one bladder is the same inflation state as the inflation means.

2. The therapeutic compression system of claim 1 wherein the at least one wrap is configured to the secured to a foot, lower leg or thigh of the user.

3. The therapeutic compression system of claim 1 wherein one bladder is capable of inflation or deflation at a different time than a second bladder.

4. The therapeutic compression system of claim 1 wherein the sensor is a switch configured to inflate at least one bladder, maintain pressure within the inflated bladder, or deflate the at least one bladder.

5. The therapeutic compression system of claim 1 further comprising a second wrap configured to wrap around a second limb of the user wherein the limb is selected from the group consisting of the foot, ankle, calf, lower leg, knee, thigh, upper leg, whole leg, waist, torso, chest, arm, shoulder, elbow, wrist, hand, neck or any combinations thereof.

6. The therapeutic compression system of claim 5 wherein the first wrap and second wrap are not connected to each other while connected to the same inflation means and wherein the second wrap either has the same or a different inflation pressure than the inflation pressure of the first wrap when both the first wrap and second wrap are inflated from the same inflation means.

7. The therapeutic compression apparatus of claim 1 further including an elastic sleeve to be placed on the limb of the user under the at least one wrap.

8. The therapeutic compression system of claim 1 wherein the inelastic portion of the at least one wrap has a static stiffness index is greater than 10.

9. The therapeutic compression system of claim 1 wherein the inelastic portion of the at least one wrap has a static stiffness index is between about 10 to about 50.

10. The therapeutic compression system of claim 1 wherein the inelastic portion of the at least one wrap has a static stiffness index is between about 20 to about 40.

11. The therapeutic compression system of claim 1 wherein the connecting means is selected from the group consisting of hoses, tubes, conduits and combinations therein.

12. The therapeutic compression system of claim 1 wherein the at least one wrap is configured to be secured on the lower leg of a user and further comprising an elastic portion configured to be placed on the calf of a user.

13. The therapeutic compression system of claim 1 wherein the at least one wrap is configured to be placed on a lower leg of a user and further comprising an elastic portion configured to be placed on the upper calf below the knee area of a user.

14. The therapeutic compression system of claim 9 or 10 wherein the at least one wrap is configured further comprises a second elastic portion configured to be placed on the ankle portion of a user.

15. The therapeutic compression system of claim 1 wherein the at least one wrap is configured to be placed on a thigh of a user and further comprising an elastic portion configured to be placed on the groin area of a user.

16. The therapeutic compression system of claim 1 wherein the at least two bladders are configured with spot welds and spot lines in a geometric pattern to apply gradient compression on the limb of the user.

17. The therapeutic compression system of claim 1 wherein the inflation means is selected from the group consisting of manual pumps, static pumps, intermittent pumps, electrical inflation pumps, battery inflation pumps, gas powered inflation pumps, static pneumatic compression pumps, intermittent pneumatic pressure pumps, and the combination thereof and the inflation means for the at least one bladder is selected from the group consisting of air, gas, fluid or combinations thereof.

18. The therapeutic compression system of claim 1, wherein the inflation means includes either a manual pump configured to provide static inflation or a powered pump configured to provide static and/or intermittent inflation.

19. The therapeutic compression system of claim 1, wherein the inflation means includes a real time pressure measurement mechanism and is connected to a securing means configured to be worn on the body of the user.

20. The therapeutic compression system of claim 1, wherein the sealing means is selected from the group consisting of valves, caps, levers, switches, screws, stop taps, stopcocks, or combinations thereof and the inflation port is a self-sealing inflation port configured to prevent deflation of the at least one bladder and includes a check valve.

21. The therapeutic compression system of claim 1 further comprising a pressure sensor operatively connected to the inflation means to protect from over inflation and wherein the check valve is set to open at a predetermined pressure or a user selectable pressure.

22. The therapeutic compression system of claim 1 wherein the wrap may be configured to wrap around a limb of the user wherein the limb is selected from the group consisting of the foot, ankle, calf, lower leg, knee, thigh, upper leg, whole leg, waist, torso, chest, arm, shoulder, elbow, wrist, hand, neck or any combinations thereof.

23. A method to reduce tissue swelling and apply compression pressure to a portion of a human body, comprising:
placing a therapeutic compression apparatus on the body part of a user, the therapeutic compression apparatus including at least one wrap having
(a) at least two air bladders connected to an inflation means,
(b) at least two universal inflation ports connected to each bladder having a sealing means configured to include (i) an open position and a closed position wherein the closed position maintains the bladder in an inflated or deflated state and is in the open position when coupled to the inflation means so that the bladder is the same inflation state as the inflation means, (2) an elbow, a check valve and a valve cap wherein the valve cap is capable of releasing a pressure created by the inflation means within the at least one air bladder, (iii) a connecting means from the universal inflation port to the inflation means,
(c) a connecting means from the universal inflation port to the inflation means having a distal and proximal end with a insertion portion on the distal end configured to insert into a manifold on the inflation means, and
(d) at least one sensor configured to inflate, hold, or deflate each of the bladders at a chosen pressure level or time period;
inserting the connecting means on the proximal end to one of the universal inflation ports and on the distal end into the manifold;
activating the inflation means and the sensors at a chosen pressure level;
inflating the first bladder and then inflating the second bladder for a period of time;
deflating the first bladder and the deflating the second bladder for a period of time;
repeating the inflation and deflation steps of the method with the last step inflation;
removing the connecting means from the universal inflation port and activating the sealing means on the universal inflation port; and
after wearing the wrap for a period of time deflating the at least one bladder by opening the sealing means and releasing a pressure within the at least one bladder.
